(19) United States
(12) Patent Application Publication
(10) Pub. No.: US 2026/0189713 A1
(43) Pub. Date: Jul. 2, 2026

(54) ELECTRONIC DEVICE AND NON-TRANSITORY MACHINE-READABLE MEDIUM FOR DECODING AND/OR ENCODING VIDEO DATA

(71) Applicant: SHARP KABUSHIKI KAISHA, Sakai City (JP)

(72) Inventors: KAI-WEN LIANG, New Taipei City (TW); Yu-Chiao Yang, New Taipei City (TW)

(21) Appl. No.: 19/436,264

(22) Filed: Dec. 30, 2025

Related U.S. Application Data
(60) Provisional application No. 63/740,231, filed on Dec. 30, 2024.

(51) Int. Cl. H04N 19/172; H04N 19/105; H04N 19/167; H04N 19/196; H04N 19/593

(52) U.S. Cl. CPC H04N 19/172; H04N 19/105; H04N 19/167; H04N 19/196; H04N 19/593

(57) ABSTRACT

A method of decoding/encoding video data is provided. The method determines a block unit of an image included in the video data, and template regions, including template samples, from the image frame. The method generates a first gradient amplitude by filtering a first set of template samples; adds the first gradient amplitude to first histogram amplitudes in a first histogram of gradient (HoG); calculates a cumulative sum of the first histogram amplitudes; compares the cumulative sum of the first histogram amplitudes with an amplitude threshold, the amplitude threshold determined based on a size parameter of the block unit; and reconstructs the block unit based on the first HoG when the cumulative sum of the first histogram amplitudes is greater than, or equal to, the amplitude threshold. An electronic device and a non-transitory machine-readable medium of an electronic device using such a method are also provided.

### CROSS-REFERENCE TO RELATED APPLICATION(S)

The present disclosure claims the benefit of and priority to U.S. Provisional Patent Application Ser. No. 63/740,231, filed on Dec. 30, 2024, entitled “BLOCK VECTOR GUIDED DIMD WITH EDGE OPERATOR,” the content of which is hereby incorporated herein fully by reference in its entirety for all purposes.

### FIELD

The present disclosure generally relates to video coding, and more specifically, to techniques for predicting and/or reconstructing a block unit by using a histogram of gradients (HoG) in decoder side intra mode deviation (DIMD) mode.

### BACKGROUND

Decoder side intra mode deviation (DIMD) mode is a coding tool for video coding, in which, an encoder and/or a decoder may predict a block unit of a current block based on an intra angular mode, selected based on a histogram of gradients (HoG).

In addition, the encoder and/or the decoder may generate multiple gradient amplitudes for multiple gradient directions by filtering multiple neighboring samples, neighboring the block unit, to derive the HoG. Each gradient direction in the HoG may correspond to a corresponding one of multiple intra angular modes. The gradient amplitudes, generated by filtering the neighboring samples, however, may be used to predict the probability of each intra direction modes, but not to evaluate the most appropriate mode. Thus, an excessive or insufficient number of neighboring samples may be inadequate to precisely and efficiently select the most appropriate intra angular mode for the block unit.

Thus, quantity adjustment for controlling the number of neighboring samples for the block unit may be required for the encoder and/or the decoder to be able to precisely and efficiently predict and/or reconstruct the block unit.

### SUMMARY

The present disclosure is directed to a non-transitory machine-readable medium and an electronic device for predicting and/or reconstructing a block unit of a current block based on an intra angular mode, selected based on a histogram of gradients (HoG) in decoder side intra mode deviation (DIMD) mode.

In a first aspect of the present disclosure, a non-transitory machine-readable medium of an electronic device storing one or more computer-executable instructions for decoding video data is provided. The one or more computer-executable instructions, when executed by at least one processor of the electronic device, cause the electronic device to: receive the video data; determine a block unit of an image frame included in the video data; determine multiple template regions, including multiple template samples, from the image frame; generate a first gradient amplitude by filtering a first set of template samples that is included in the multiple template samples; add the first gradient amplitude to multiple first histogram amplitudes in a first histogram of gradient (HoG); calculate a cumulative sum of the multiple first histogram amplitudes; compare the cumulative sum of the multiple first histogram amplitudes with an amplitude threshold, the amplitude threshold determined based on a size parameter of the block unit; and reconstruct the block unit based on the first HoG when the cumulative sum of the multiple first histogram amplitudes is greater than, or equal to, the amplitude threshold.

In an implementation of the first aspect of the present disclosure, the multiple template regions further includes at least one guiding region that is determined from multiple block-vector-guided regions, and the multiple block-vector-guided regions includes at least one block-vector-guided reference block and at least one block-vector-guided reference region, each of the at least one block-vector-guided reference region neighboring a corresponding one of the at least one block-vector-guided reference block.

In an implementation of the first aspect of the present disclosure, the one or more computer-executable instructions, when executed by the at least one processor of the electronic device, further cause the electronic device to: generate a second gradient amplitude by filtering a second set of template samples that is included in a specific one of the at least one guiding region, where: the multiple template regions further includes a neighboring region that neighbors the block unit and that is different from the multiple block-vector-guided regions, and the first set of template samples is included in the neighboring region and is different from the second set of template samples; and add the second gradient amplitude to the multiple first histogram amplitudes in the first HoG.

In an implementation of the first aspect of the present disclosure, adding the second gradient amplitude to the multiple first histogram amplitudes in the first HoG further includes: determining a magnitude of a block vector, where the specific one of the at least one guiding region is determined based on the block vector, determining a weighted parameter of the second gradient amplitude based on the magnitude of the block vector, multiplying the second gradient amplitude by the weighted parameter of the second gradient amplitude to generate a weighted amplitude, and adding the weighted amplitude to the multiple first histogram amplitudes in the first HoG.

In an implementation of the first aspect of the present disclosure, reconstructing the block unit based on the first HoG further includes: generating a second gradient amplitude by filtering a second set of template samples that is included in a specific one of the at least one guiding region, where: the multiple template regions further includes a neighboring region that neighbors the block unit and that is different from the multiple block-vector-guided regions, and the first set of template samples is included in the neighboring region and is different from the second set of template samples; adding the second gradient amplitude to multiple second histogram amplitudes in a second HoG; calculating a cumulative sum of the multiple second histogram amplitudes; comparing the cumulative sum of the multiple second histogram amplitudes with the amplitude threshold; and reconstructing the block unit further based on the second HoG when the cumulative sum of the multiple second histogram amplitudes is greater than, or equal to, the amplitude threshold.

In an implementation of the first aspect of the present disclosure, the one or more computer-executable instructions, when executed by the at least one processor of the electronic device, further cause the electronic device to: when the cumulative sum of the multiple first histogram amplitudes is greater than, or equal to, the amplitude threshold, terminate filtering the multiple template samples; and when the cumulative sum of the multiple first histogram amplitudes is less than the amplitude threshold: generate a second gradient amplitude by filtering a second set of template samples that is included in the multiple template samples, add the second gradient amplitude to the multiple first histogram amplitudes in the first HoG, update the cumulative sum of the multiple first histogram amplitudes, and compare the updated cumulative sum of the multiple first histogram amplitudes with the amplitude threshold for determining whether to continue on filtering the multiple template samples, where the second set of template samples is different from the first set of template samples.

In an implementation of the first aspect of the present disclosure, determining the multiple template regions from the image frame comprises determining the multiple template regions based on a neighboring region that neighbors the block unit and that includes multiple neighboring lines, wherein a number of the multiple neighboring lines is equal to a number N, wherein N is a positive integer, greater than one, and the one or more computer-executable instructions, when executed by the at least one processor of the electronic device, further cause the electronic device to: add one to the number N of the neighboring lines to update the multiple template regions when all of the multiple template samples has been filtered and the cumulative sum of the multiple first histogram amplitudes is still less than the amplitude threshold; and generate a second gradient amplitude by filtering a second set of template samples that is included in the multiple updated template regions.

In an implementation of the first aspect of the present disclosure, the amplitude threshold is equal to a first threshold candidate when the size parameter of the block unit is equal to, or less than, a size threshold, the amplitude threshold is equal to, or greater than, a second threshold candidate when the size parameter of the block unit is greater than the size threshold, the second threshold candidate is greater than the first threshold candidate, and the first and second threshold candidates are positive integers.

In an implementation of the first aspect of the present disclosure, the one or more computer-executable instructions, when executed by the at least one processor of the electronic device, further cause the electronic device to: select multiple intra prediction modes from multiple intra angular modes based on the first HoG, where each of the multiple first histogram amplitudes, that is included in the first HoG, corresponds to one of the multiple intra angular modes; predict the block unit based on the multiple intra prediction modes to generate multiple intra-predicted blocks; and reconstruct the block unit further by weightedly combining the multiple intra-predicted blocks.

In a second aspect of the present disclosure, an electronic device for decoding video data is provided. The electronic device includes at least one processor and at least one non-transitory computer-readable medium that is coupled to the at least one processor. The at least one non-transitory computer-readable medium stores one or more computer-executable instructions that, when executed by the at least one processor, cause the electronic device to: receive the video data; determine a block unit of an image frame included in the video data; determine multiple template regions, including multiple template samples, from the image frame; generate a first gradient amplitude by filtering a first set of template samples that is included in the multiple template samples; add the first gradient amplitude to multiple first histogram amplitudes in a first histogram of gradient (HoG); calculate a cumulative sum of the multiple first histogram amplitudes; compare the cumulative sum of the multiple first histogram amplitudes with an amplitude threshold, the amplitude threshold determined based on a size parameter of the block unit; and reconstruct the block unit based on the first HoG when the cumulative sum of the multiple first histogram amplitudes is greater than, or equal to, the amplitude threshold.

In an implementation of the second aspect of the present disclosure, the multiple template regions further includes at least one guiding region that is determined from multiple block-vector-guided regions, and the multiple block-vector-guided regions includes at least one block-vector-guided reference block and at least one block-vector-guided reference region, each of the at least one block-vector-guided reference region neighboring a corresponding one of the at least one block-vector-guided reference block.

In an implementation of the second aspect of the present disclosure, the one or more computer-executable instructions, when executed by the at least one processor of the electronic device, further cause the electronic device to: generate a second gradient amplitude by filtering a second set of template samples that is included in a specific one of the at least one guiding region, where: the multiple template regions further includes a neighboring region that neighbors the block unit and that is different from the multiple block-vector-guided regions, and the first set of template samples is included in the neighboring region and is different from the second set of template samples; and add the second gradient amplitude to the multiple first histogram amplitudes in the first HoG.

In an implementation of the second aspect of the present disclosure, adding the second gradient amplitude to the multiple first histogram amplitudes in the first HoG further includes: determining a magnitude of a block vector, where the specific one of the at least one guiding region is determined based on the block vector, determining a weighted parameter of the second gradient amplitude based on the magnitude of the block vector, multiplying the second gradient amplitude by the weighted parameter of the second gradient amplitude to generate a weighted amplitude, and adding the weighted amplitude to the multiple first histogram amplitudes in the first HoG.

In an implementation of the second aspect of the present disclosure, reconstructing the block unit based on the first HoG further includes: generating a second gradient amplitude by filtering a second set of template samples that is included in a specific one of the at least one guiding region, where: the multiple template regions further includes a neighboring region that neighbors the block unit and that is different from the multiple block-vector-guided regions, and the first set of template samples is included in the neighboring region and is different from the second set of template samples; adding the second gradient amplitude to multiple second histogram amplitudes in a second HoG; calculating a cumulative sum of the multiple second histogram amplitudes; comparing the cumulative sum of the multiple second histogram amplitudes with the amplitude threshold; and reconstructing the block unit further based on the second HoG when the cumulative sum of the multiple second histogram amplitudes is greater than, or equal to, the amplitude threshold.

In an implementation of the second aspect of the present disclosure, the one or more computer-executable instructions, when executed by the at least one processor of the electronic device, further cause the electronic device to: when the cumulative sum of the multiple first histogram amplitudes is greater than, or equal to, the amplitude threshold, terminate filtering the multiple template samples; and when the cumulative sum of the multiple first histogram amplitudes is less than the amplitude threshold: generate a second gradient amplitude by filtering a second set of template samples that is included in the multiple template samples, add the second gradient amplitude to the multiple first histogram amplitudes in the first HoG, update the cumulative sum of the multiple first histogram amplitudes, and compare the updated cumulative sum of the multiple first histogram amplitudes with the amplitude threshold for determining whether to continue on filtering the multiple template samples, where the second set of template samples is different from the first set of template samples.

In an implementation of the second aspect of the present disclosure, determining the multiple template regions from the image frame comprises determining the multiple template regions based on a neighboring region that neighbors the block unit and that includes multiple neighboring lines, wherein a number of the multiple neighboring lines is equal to a number N, wherein N is a positive integer, greater than one, and the one or more computer-executable instructions, when executed by the at least one processor of the electronic device, further cause the electronic device to: add one to the number N of the neighboring lines to update the multiple template regions when all of the multiple template samples has been filtered and the cumulative sum of the multiple first histogram amplitudes is still less than the amplitude threshold; and generate a second gradient amplitude by filtering a second set of template samples that is included in the multiple updated template regions.

In an implementation of the second aspect of the present disclosure, the amplitude threshold is equal to a first threshold candidate when the size parameter of the block unit is equal to, or less than, a size threshold, the amplitude threshold is equal to, or greater than, a second threshold candidate when the size parameter of the block unit is greater than the size threshold, the second threshold candidate is greater than the first threshold candidate, and the first and second threshold candidates are positive integers.

In an implementation of the second aspect of the present disclosure, the one or more computer-executable instructions, when executed by the at least one processor of the electronic device, further cause the electronic device to: select multiple intra prediction modes from multiple intra angular modes based on the first HoG, where each of the multiple first histogram amplitudes, that is included in the first HoG, corresponds to one of the multiple intra angular modes; predict the block unit based on the multiple intra prediction modes to generate multiple intra-predicted blocks; and reconstruct the block unit further by weightedly combining the multiple intra-predicted blocks.

In a third aspect of the present disclosure, an electronic device for encoding video data is provided. The electronic device includes at least one processor and at least one non-transitory computer-readable medium that is coupled to the at least one processor. The at least one non-transitory computer-readable medium stores one or more computer-executable instructions that, when executed by the at least one processor, cause the electronic device to: receive the video data; determine a block unit of an image frame included in the video data; determine multiple template regions, including multiple template samples, from the image frame; generate a first gradient amplitude by filtering a first set of template samples that is included in the multiple template samples; add the first gradient amplitude to multiple first histogram amplitudes in a first histogram of gradient (HoG); calculate a cumulative sum of the multiple first histogram amplitudes; compare the cumulative sum of the multiple first histogram amplitudes with an amplitude threshold, the amplitude threshold determined based on a size parameter of the block unit; and reconstruct the block unit based on the first HoG when the cumulative sum of the multiple first histogram amplitudes is greater than, or equal to, the amplitude threshold.

In an implementation of the third aspect of the present disclosure, the multiple template regions further includes at least one guiding region that is determined from multiple block-vector-guided regions, and the multiple block-vector-guided regions includes at least one block-vector-guided reference block and at least one block-vector-guided reference region, each of the at least one block-vector-guided reference region neighboring a corresponding one of the at least one block-vector-guided reference block.

In an implementation of the third aspect of the present disclosure, the one or more computer-executable instructions, when executed by the at least one processor of the electronic device, further cause the electronic device to: generate a second gradient amplitude by filtering a second set of template samples that is included in a specific one of the at least one guiding region, where: the multiple template regions further includes a neighboring region that neighbors the block unit and that is different from the multiple block-vector-guided regions, and the first set of template samples is included in the neighboring region and is different from the second set of template samples; and add the second gradient amplitude to the multiple first histogram amplitudes in the first HoG.

In an implementation of the third aspect of the present disclosure, adding the second gradient amplitude to the multiple first histogram amplitudes in the first HoG further includes: determining a magnitude of a block vector, where the specific one of the at least one guiding region is determined based on the block vector, determining a weighted parameter of the second gradient amplitude based on the magnitude of the block vector, multiplying the second gradient amplitude by the weighted parameter of the second gradient amplitude to generate a weighted amplitude, and adding the weighted amplitude to the multiple first histogram amplitudes in the first HoG.

In an implementation of the third aspect of the present disclosure, reconstructing the block unit based on the first HoG further includes: generating a second gradient amplitude by filtering a second set of template samples that is included in a specific one of the at least one guiding region, where: the multiple template regions further includes a neighboring region that neighbors the block unit and that is different from the multiple block-vector-guided regions, and the first set of template samples is included in the neighboring region and is different from the second set of template samples; adding the second gradient amplitude to multiple second histogram amplitudes in a second HoG; calculating a cumulative sum of the multiple second histogram amplitudes; comparing the cumulative sum of the multiple second histogram amplitudes with the amplitude threshold; and reconstructing the block unit further based on the second HoG when the cumulative sum of the multiple second histogram amplitudes is greater than, or equal to, the amplitude threshold.

In an implementation of the third aspect of the present disclosure, the one or more computer-executable instructions, when executed by the at least one processor of the electronic device, further cause the electronic device to: when the cumulative sum of the multiple first histogram amplitudes is greater than, or equal to, the amplitude threshold, terminate filtering the multiple template samples; and when the cumulative sum of the multiple first histogram amplitudes is less than the amplitude threshold: generate a second gradient amplitude by filtering a second set of template samples that is included in the multiple template samples, add the second gradient amplitude to the multiple first histogram amplitudes in the first HoG, update the cumulative sum of the multiple first histogram amplitudes, and compare the updated cumulative sum of the multiple first histogram amplitudes with the amplitude threshold for determining whether to continue on filtering the multiple template samples, where the second set of template samples is different from the first set of template samples.

In an implementation of the third aspect of the present disclosure, determining the multiple template regions from the image frame comprises determining the multiple template regions based on a neighboring region that neighbors the block unit and that includes multiple neighboring lines, wherein a number of the multiple neighboring lines is equal to a number N, wherein N is a positive integer, greater than one, and the one or more computer-executable instructions, when executed by the at least one processor of the electronic device, further cause the electronic device to: add one to the number N of the neighboring lines to update the multiple template regions when all of the multiple template samples has been filtered and the cumulative sum of the multiple first histogram amplitudes is still less than the amplitude threshold; and generate a second gradient amplitude by filtering a second set of template samples that is included in the multiple updated template regions.

In an implementation of the third aspect of the present disclosure, the amplitude threshold is equal to a first threshold candidate when the size parameter of the block unit is equal to, or less than, a size threshold, the amplitude threshold is equal to, or greater than, a second threshold candidate when the size parameter of the block unit is greater than the size threshold, the second threshold candidate is greater than the first threshold candidate, and the first and second threshold candidates are positive integers.

In an implementation of the third aspect of the present disclosure, the one or more computer-executable instructions, when executed by the at least one processor of the electronic device, further cause the electronic device to: select multiple intra prediction modes from multiple intra angular modes based on the first HoG, where each of the multiple first histogram amplitudes, that is included in the first HoG, corresponds to one of the multiple intra angular modes; predict the block unit based on the multiple intra prediction modes to generate multiple intra-predicted blocks; and reconstruct the block unit further by weightedly combining the multiple intra-predicted blocks.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIGS. 4A and 4B are schematic diagrams illustrating multiple neighboring regions and multiple guiding regions of the template regions, in accordance with one or more example implementations of this disclosure.

FIGS. 5A and 5B are schematic diagrams illustrating different neighboring regions having different neighboring lines, in accordance with one or more example implementations of this disclosure.

FIG. 6 is a flowchart illustrating a method/process for decoding and/or encoding video data by an electronic device, in accordance with one or more example implementations of this disclosure.

FIG. 7 is a block diagram illustrating an encoder module of the first electronic device illustrated in FIG. 1, in accordance with one or more example implementations of this disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on at least one computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium or a non-transitory machine-readable medium.

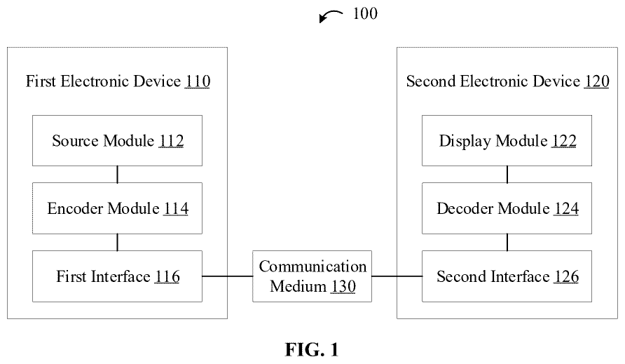

FIG. 1 is a block diagram illustrating a system 100 having a first electronic device and a second electronic device for encoding and decoding video data, in accordance with one or more example implementations of this disclosure.

The system 100 may include a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and/or the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

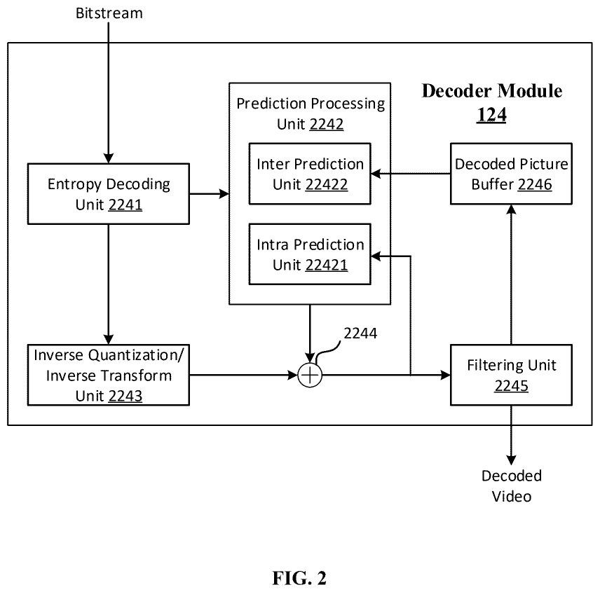

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames based on the partition information.

Each of the image frames may be divided into at least one image block based on the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame, as the current block unit, based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components are reconstructed by using the prediction processing unit 2242.

The intra prediction unit 22421 may reconstruct multiple chroma components of the current block unit based on the multiple luma components of the current block unit when the multiple luma components of the current block unit are reconstructed by using the prediction processing unit 2242.

The inter prediction unit 22422 may perform inter-predictive coding of the current block unit relative to one or more blocks in one or more reference image blocks based on syntax elements related to the motion vector in order to generate the predicted block. The motion vector may indicate a displacement of the current block unit within the current image block relative to a reference block unit within the reference image block. The reference block unit may be a block determined to closely match the current block unit. The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (are not explicitly illustrated for brevity of the description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

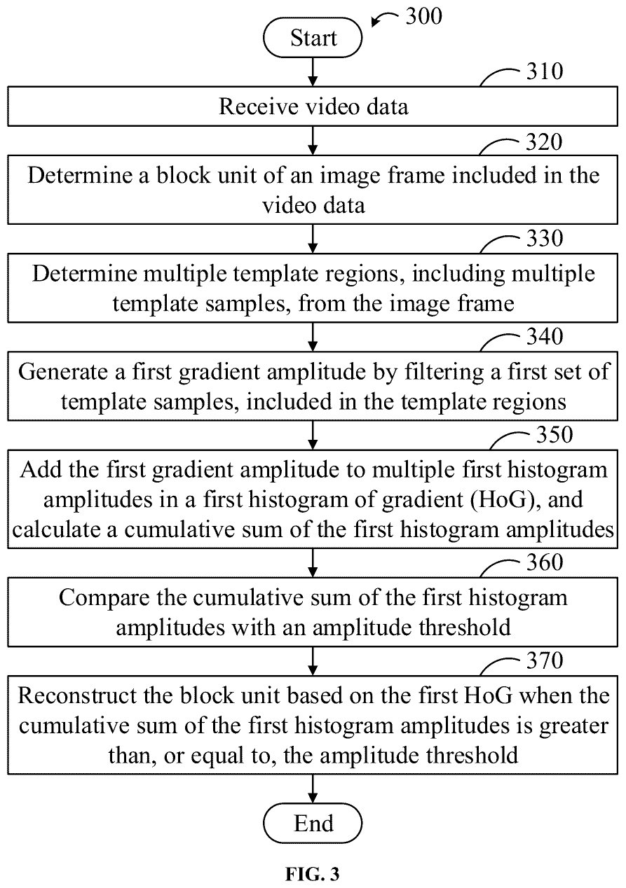

FIG. 3 is a flowchart illustrating a method/process 300 for decoding and/or encoding video data by an electronic device, in accordance with one or more example implementations of this disclosure. The method/process 300 is an example implementation, as there may be a variety of mechanisms of decoding the video data.

The method/process 300 may be performed by an electronic device using the configurations illustrated in FIGS. 1 and/or 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus the order may be different from what is illustrated. Additional blocks may be added or fewer blocks may be utilized without departing from the scope of the present disclosure.

With reference to FIG. 3, at block 310, the method/process 300 may start by receiving (e.g., via the decoder module 124, as shown in FIG. 2) the video data. The video data, received by the decoder module 124, may include a bitstream.

With reference to FIGS. 1 and 2, the second electronic device 120 may receive the bitstream from an encoder, such as the first electronic device 110 (or other video providers), via the second interface 126.

At block 320, the decoder module 124 may determine a block unit of an image frame included in the video data.

With reference to FIGS. 1 and 2, the decoder module 124 may determine the image frames, included in the bitstream, when the video data, received by the decoder module 124, includes the bitstream. The current frame may be one of the image frames, determined based on the bitstream. The decoder module 124 may further divide the current frame to determine the block unit, according to the partition indications in the bitstream. In some implementations, the decoder module 124 may divide the current frame to generate multiple CTUs, and may further divide a current CTU, included in the CTUs, to generate multiple divided blocks and to determine the block unit from the divided blocks, according to the partition indications (e.g., based on any video coding standard).

In some other implementations, the decoder module 124 may divide the current frame to generate multiple slices or multiple tiles, and may further divide a current slice or a current tile, included in the slices or the tiles, to generate multiple CTUs. In addition, the decoder module 124 may further divide a current CTU, included in the CTUs, to generate multiple divided blocks and to determine the block unit from the divided blocks, based on the partition indications.

The block size Wb×Hb of the block unit may be determined based on a block width Wb and a block height Hb. In addition, a block location of the block unit may be represented by (xCb, yCb) specifying a top-left luma sample of the block unit relative to a top-left luma sample of the current frame.

Referring back to FIG. 3, at block 330, the decoder module 124 may determine multiple template regions, including multiple template samples, from the image frame.

With reference to FIGS. 1 and 2, the decoder module 124 may determine multiple neighboring regions that neighbor the block unit. Furthermore, the decoder module 124 may further determine at least one guiding region from multiple block-vector-guided (BV-guided) regions. The BV-guided regions may further include at least one BV-guided reference block and at least one BV-guided reference region. Each of the at least one BV-guided reference region may neighbor a corresponding one of the at least one BV-guided reference block. In some implementations, the neighboring regions may be different from the BV-guided regions.

In some implementations, the template regions may only include one or more of the neighboring regions. In some other implementations, the template regions may include one or more of the neighboring regions and the at least one guiding region, that is selected only from the at least one BV-guided reference region. In some other implementations, the template regions may include one or more of the neighboring regions and the at least one guiding region, that is selected from the BV-guided regions, that include the at least one BV-guided reference block and the at least one BV-guided reference region.

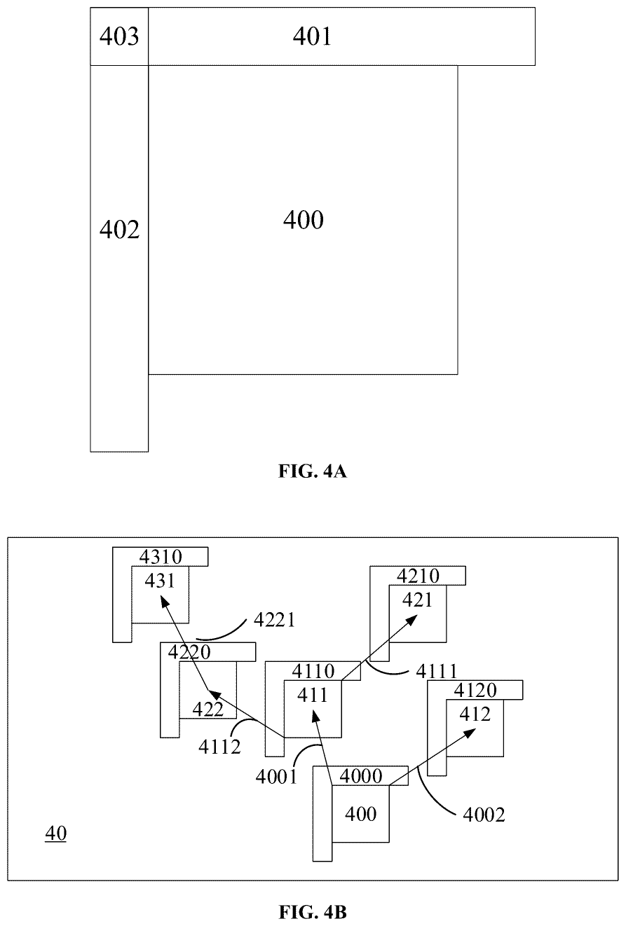

FIGS. 4A and 4B are schematic diagrams illustrating multiple neighboring regions and multiple guiding regions of the template regions, in accordance with one or more example implementations of this disclosure.

FIG. 4A illustrates a block unit 400 and three neighboring regions 401-403, neighboring the block unit 400. The neighboring regions 401-403 may include a top neighboring region 401, located above the block unit 400, a left neighboring region 402, located at the left side of the block unit 400, and a top-left neighboring region 403, located at the top-left side of the block unit 400. In some implementations, the template regions may include one or more of the neighboring regions 401-403. In some implementations, the one or more neighboring regions, that are included in the template regions, may have the same shape and size, as the at least one BV-guided reference region, that neighbors the at least one BV-guided reference block. Thus, the one or more neighboring regions, that are included in the template regions, may be combined to be determined as a single neighboring region.

FIG. 4B illustrates the block unit 400, a neighboring region 4000, five BV-guided reference blocks 411, 412, 421, 422, and 431, and five BV-guided reference regions 4110, 4120, 4210, 4220, and 4310. In some implementations, the block unit 400, the neighboring region 4000, the BV-guided reference blocks 411, 412, 421, 422, and 431, and the BV-guided reference regions 4110, 4120, 4210, 4220, and 4310 may be included in a current frame 40. The neighboring region 4000 may include three neighboring regions (e.g. the three neighboring regions 401-403 shown in FIG. 4A). The BV-guided reference blocks 411, 412, 421, 422, and 431 may be determined based on five guiding vectors 4001, 4002, 4011, 4012, and 4221. Each of the BV-guided reference regions 4110, 4120, 4210, 4220, and 4310 may neighbor a corresponding one of the BV-guided reference blocks 411, 412, 421, 422, and 431.

The decoder module 124 may search for the guiding vectors for the block unit 400. In FIG. 4B, the decoder module 124 may determine two different guiding vectors 4001 and 4002 for the block unit 400. Vector directions and magnitudes of guiding vectors 4001 and 4002 may be, respectively, identical to vector directions and magnitudes of two block vectors, used to predict and/or reconstruct adjacent reconstructed blocks that cover one of four corners of the block unit 400. The corners, covered by the adjacent reconstructed blocks, may be set as start points of the guiding vectors.

For example, the BV-guided reference block 411 may be indicated by the guiding vector 4001 that starts from the top-left corner of the block unit 400 and ends at the center position of the BV-guided reference blocks 411. Thus, a vector direction and a magnitude of the guiding vector 4001 may be identical to a vector direction and a magnitude of a block vector, used to predict and/or reconstruct the adjacent reconstructed block that covers the top-left corner of the block unit 400. The method to determine the other BV-guided reference blocks 412, 421, 422, and 431 may be identical to the method of determining the BV-guided reference block 411.

In some implementations, the adjacent reconstructed blocks that cover one of four corners of the block unit 400 may be predicted and/or reconstructed in one of an Intra Block Copy (IBC) mode and an Intra Template Matching Prediction (IntraTMP) mode. In some implementations, the adjacent reconstructed blocks that cover, respectively, one of the four corners of the BV-guided reference blocks 411, 421, or 422 may be predicted and/or reconstructed in one of the IBC mode and the IntraTMP mode. Thus, the three guiding vectors 4111, 4112, and 422 may be identical, respectively, to the three block vectors used to predict and/or reconstruct the adjacent reconstructed blocks that cover the corresponding corners of the BV-guided reference blocks 411, 421, and 422.

It should be understood that the determination method of the BV-guided reference blocks, including the search method for the block vector of the adjacent reconstructed blocks, the start and end points of the guiding vector, and the like, is not limited to the implementations described above. Various rearrangements, modifications, and substitutions, regarding the vector determination method, are possible without departing from the scope of the present disclosure.

In some implementations, the one or more neighboring regions, included in the template regions, may have the same shape and size, as the at least one BV-guided reference region, neighboring the at least one BV-guided reference block. Thus, the neighboring region 4000, included in the template regions, may have the same shape and size, as the BV-guided reference regions 4110, 4120, 4210, 4220, and 4310.

In some implementations, the template regions may include multiple template samples. The neighboring region 4000 and the BV-guided reference regions 4110, 4120, 4210, 4220, and 4310 may be predicted and/or reconstructed prior to the prediction and/or reconstruction of the block unit 400. Thus, the template samples, included in the template regions, may be multiple reconstructed samples, included in the template regions, when the block unit 400 is being predicted and/or reconstructed.

Referring back to FIG. 3, at block 340, the decoder module 124 may generate a first gradient amplitude by filtering a first set of template samples, included in the template samples.

With reference to FIGS. 1 and 2, the decoder module 124 may filter the template samples in the template regions. The template samples may be predicted and/or reconstructed prior to the prediction and/or reconstruction of the block unit 400. The template samples may be filtered to generate multiple template gradients by using a gradient filter. Thus, the neighboring region 4000, the BV-guided reference blocks 411, 412, 421, 422, and 431, and the BV-guided reference regions 4110, 4120, 4210, 4220, and 4310, as shown in FIG. 4A, may be filtered.

In some implementations, the gradient filter may be a Sobel filter. The template gradients may be generated by filtering the template samples based on the following filtering equations (1) and (2):

$${G}_{x} = [ \begin{matrix}- 1 & - 2 & - 1 \\ 0 & 0 & 0 \\ + 1 & + 2 & + 1\end{matrix} ] * A \qquad ( 1 )$$

$${G}_{y} = [ \begin{matrix}+ 1 & 0 & - 1 \\ + 2 & 0 & - 2 \\ + 1 & 0 & - 1\end{matrix} ] * A \qquad ( 2 )$$

where the operator * represents a 2-dimensional signal processing convolution operation, and the matrix A represents one of multiple sets of template samples in the template regions. In other words, each of the template gradients may be generated based on one of the sets of template samples in the template regions. Each of the sets of template samples may include Nf reconstructed samples. The number Nf may be a positive integer. For example, the number Nf may be equal to nine when a filter size of the gradient filter is 3×3.

In some implementations, the template gradients may be generated by filtering the template samples based on the following filtering equations (3) and (4):

$${G}_{x} = [ \begin{matrix}- 1 & - 1 \\ + 1 & + 1\end{matrix} ] * B \qquad ( 3 )$$

$${G}_{y} = [ \begin{matrix}+ 1 & - 1 \\ + 1 & - 1\end{matrix} ] * B \qquad ( 4 )$$

where the operator * represents a 2-dimensional signal processing convolution operation, and the matrix B represents one of the sets of template samples in the template regions. In other words, each of the template gradients may be generated based on one of the sets of template samples in the template regions. Each of the sets of template samples may include Nf reconstructed samples. The number Nf may be a positive integer. For example, the number Nf may be equal to nine when a filter size of the gradient filter is 2×2.

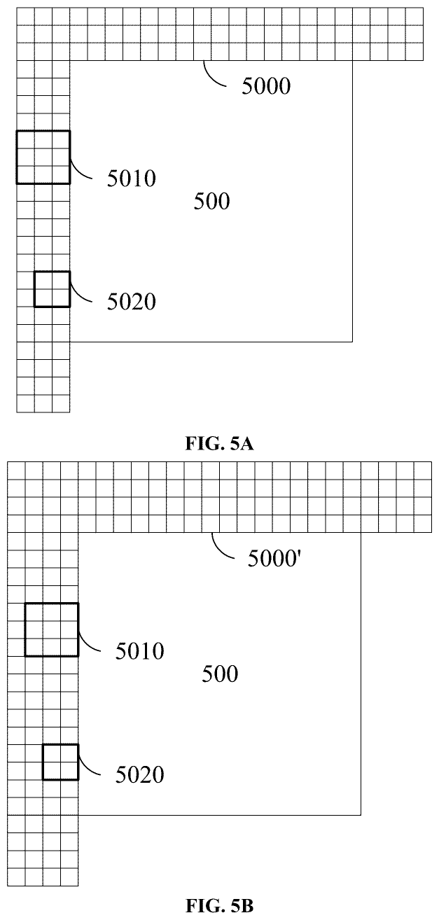

FIGS. 5A and 5B are schematic diagrams illustrating different neighboring regions having different neighboring lines, in accordance with one or more example implementations of this disclosure. FIG. 5A is an illustration of an example implementation of a block unit 500 and a neighboring region 5000 neighboring the block unit 500. FIG. 5B is an illustration of an example implementation of a block unit 500 and another neighboring region 5000′ neighboring the block unit 500. The decoder module 124 may determine the neighboring region 5000 and/or the neighboring region 5000′, both neighboring the block unit 500. The neighboring regions 5000 and 5000′ may include multiple template samples. The template samples, include in the neighboring regions 5000 and 5000s may be predicted and/or reconstructed prior to the prediction and/or reconstruction of the block unit 500.

In some implementations, when the filter size of the gradient filter is 3×3, a size of a specific set of template samples, included in a first set region 5010, may be 3×3. In some implementations, when the filter size of the gradient filter is 2×2, a size of a specific set of template samples, included in a second set region 5020, may be 2×2. In some implementations, when the filter size of the gradient filter is 3×3, a size of a specific set of template samples, included in a third set region 5030, may be 3×3. In some implementations, when the filter size of the gradient filter is 2×2, a size of a specific set of template samples, included in a fourth set region 5040, may be 2×2.

In some implementations, the filter size of the gradient filter may be selected based on a size parameter of the block unit 500. In some implementations, the decoder module 124 may select the gradient filter from multiple filter candidates based on the size parameter of the block unit 500.

In some implementations, the filter size of the gradient filter may be determined only based on the block width Wb of the block unit when the size parameter of the block unit is the block width Wb of the block unit. In some implementations, the filter size of the gradient filter may be determined only based on the block height Hb of the block unit when the size parameter of the block unit is the block height Hb of the block unit. In some implementations, the filter size of the gradient filter may be determined based on a size product Wb×Hb, generated by multiplying the block width Wb by the block height Hb, when the size parameter of the block unit is the size product Wb×Hb.

In some implementations, the filter size of the gradient filter may be determined based on a size ratio (Wb/Hb), generated by dividing the block width Wb by the block height Hb, when the size parameter of the block unit is the size ratio (Wb/Hb). In some implementations, the filter size of the gradient filter may be determined based on a size ratio (Hb/Wb), generated by dividing the block height Hb by the block width Wb, when the size parameter of the block unit is the size ratio (Hb/Wb). In some implementations, the filter size of the gradient filter may be determined based on a size pair (Wb, Hb), including the block width Wb and the block height Hb, when the size parameter of the block unit is the size pair (Wb, Hb).

In some implementations, the filter size of the gradient filter may increase, or remain unchanged, when the size parameter of the block unit increases. In addition, the filter size of the gradient filter may decrease, or remain unchanged, when the size parameter of the block unit decreases. In some implementations, when the size parameter is one of the block width Wb, the block height Hb, the size product Wb×Hb, the size ratio (Wb/Hb), and the size ratio (Hb/Wb), the size parameter may be compared with a first size threshold. In some implementations, the first size threshold may be predefined in the decoder module 124 and the encoder module 114.

In some implementations, the filter size of the gradient filter may be equal to a first size candidate when the size parameter of the block unit is equal to, or less than, the first size threshold. In addition, the filter size of the gradient filter may be equal to a second size candidate, when the size parameter of the block unit is greater than the first size threshold. The second size candidate may be greater than the first size candidate. For example, the filter size of the gradient filter may be 3×3 when the size parameter of the block unit is equal to, or less than, sixty-four. In addition, the filter size of the gradient filter may be 5×5 when the size parameter of the block unit is greater than sixty-four. In addition, for example, the filter size of the gradient filter may be 2×2 when the size parameter of the block unit is equal to, or less than, sixteen. In addition, the filter size of the gradient filter may be 3×3 when the size parameter of the block unit is greater than sixteen. In some implementations, the first and second size candidates may be determined from each other. Thus, the first size threshold may be used to select the gradient filter and the filter size.

In some implementations, the decoder module 124 may determine the filter size of the gradient filter based on the size parameter of the block unit, by using a size table. In some implementations, the size table, including multiple size candidates, may be predefined in the decoder module 124 and the encoder module 114. Each of the size candidates, included in the size table, may correspond to one of multiple size combinations, generated from multiple width candidates and multiple height candidates. The number of width candidates may be a positive integer, such as five, six, seven, or eight, and the number of height candidates may also be a positive integer, such as five, six, seven, or eight. In addition, each of the size combinations may correspond to one of the size candidates in the size table. When the decoder module 124 determines the filter size of the gradient filter, by comparing the size parameter with the size combinations in the size table, the decoder module 124 may compare the size pair (Wb, Hb) with the size combinations.

In some implementations, the template samples in the BV-guided regions, including the at least one BV-guided reference block and the at least one BV-guided reference region, may be preset to be filtered only by the gradient filter, having the small filter size 2×2. In other words, the template samples in the BV-guided regions, including the at least one BV-guided reference block and the at least one BV-guided reference region, may not be filtered by the gradient filter, having the other filter sizes.

In some implementations, when the template samples in the BV-guided regions are preset to be filtered only by the gradient filter, having the small filter size 2×2, the template samples in the neighboring regions may also be filtered only by the gradient filter, having the small filter size 2×2. Thus, when the template samples in the BV-guided regions are filtered, all of the template samples in the template regions may be filtered only by the gradient filter, having the small filter size 2×2. In other words, the gradient filter of the neighboring regions may be identical to the gradient filter of the BV-guided regions when the template samples in the BV-guided regions are filtered.

In some other implementations, when the template samples in the BV-guided regions are preset to be filtered only by the gradient filter, having the small filter size 2×2, the template samples in the neighboring regions may be filtered by the gradient filter, having one of the small filter size 2×2 and the other filter sizes. Thus, the gradient filter of the neighboring regions may be identical to, or different from, the gradient filter of the BV-guided regions.

It should be noted that the usage scenarios and the conditions of the small filter size 2×2, described above, may be also applicable to the normal decoder side intra mode deviation (DIMD) mode and any other differential DIMD prediction modes.

The template gradients of the filtered template samples may be further computed to generate multiple gradient amplitudes and multiple gradient angles. Thus, the template regions may be filtered by using the gradient filter for generating the gradient angles and the gradient amplitudes. Each of the gradient amplitudes may be generated by deriving a sum of an absolute value of a corresponding one of the template gradients. In addition, each of the gradient angles may be derived based on a divided result of two fractional gradients Gx and Gy. The gradient amplitudes Amp and the gradient angles Angle may, respectively, be derived by the following equations (5) and (6):

$$Amp = abs ( {G}_{x} ) + abs ( {G}_{y} ) \qquad ( 5 )$$

$$Angle = arctan ( \frac{{G}_{y}}{{G}_{x}} ) \qquad ( 6 )$$

In some implementations, the decoder module 124 may filter the first set of template samples, included in the neighboring regions of the template regions, to generate a first one of the template gradients. The first gradient amplitude and a first gradient angle may be generated based on the first template gradient. In some implementations, the decoder module 124 may filter a second set of template samples, included in a specific one of the at least one guiding region of the template regions, to generate a second one of the template gradients. A second gradient amplitude and a second gradient angle may be generated based on the second template gradient. Since the first set of template samples is included in the neighboring regions and the second set of template samples is included in the specific guiding region, the first set of template samples may be different from the second set of template samples.

Referring back to FIG. 3, at block 350, the decoder module 124 may add the first gradient amplitude to multiple first histogram amplitudes in a first histogram of gradient (HoG). In addition, the decoder module 124 may further calculate a cumulative sum of the first histogram amplitudes.

With reference to FIGS. 1 and 2, the decoder module 124 may determine the first HoG based on the gradient amplitudes and the gradient angles to generate the first histogram amplitudes. When the first gradient amplitude is generated, the first gradient amplitude may be added to the first histogram amplitudes in the first HoG.

A predefined relationship between the gradient angles and multiple intra angular modes may be predefined in the first electronic device 110 and the second electronic device 120. For example, the relationship may be stored in form of a look-up table (LUT), an equation, or a combination thereof. The intra angular modes may be included in multiple intra default modes. The intra default modes may further include multiple non-angular modes. The non-angular modes may include a Planar mode and a DC mode. In addition, the number of the angular modes may be equal to 32 for the method 300 when the decoder module 124 decodes the block unit in high efficiency video coding (HEVC). The number of the angular modes may be equal to 65 for the method 300 when the decoder module 124 decodes the block unit in versatile video coding (VVC) or VVC test model (VTM). Furthermore, the number of the angular modes may be equal to 129 for the method 300 when the decoder module 124 decodes the block unit in enhanced compression model (ECM).

When the gradient angles are determined, the decoder module 124 may generate at least one mapping mode by mapping each of the gradient angles to one of the intra angular modes based on the predefined relationship. In other words, the at least one mapping mode may be generated by mapping each of the gradient angles to the intra angular modes. For example, when each of the gradient angles of the block unit corresponds to the same intra angular mode, the number of the at least one mapping mode may be equal to one. In addition, when some of the gradient angles of the block unit correspond to different intra angular modes, the number of the at least one mapping mode may be greater than one. In some implementations, 360 degrees may be divided into multiple sections, and each section may represent an intra prediction index, corresponding to one of the intra angular modes. Thus, if one of the gradient angles falls into one section, the intra prediction index corresponding to the section may be derived according to the mapping rules.

The template gradient of a specific set of template samples may be computed to generate a specific one of the gradient amplitudes and a specific one of the gradient angles. Thus, the specific gradient amplitude may correspond to the specific gradient angle. In other words, each of the gradient angles may correspond to a corresponding one of the gradient amplitudes. When the at least one mapping mode is determined, the decoder module 124 may generate the first HoG by accumulating the gradient amplitudes based on the at least one mapping mode. For example, when two gradient angles, different from each other, correspond to the same one of the intra angular modes, two gradient amplitudes of the two gradient angles may be accumulated for one mapping mode, corresponding to the two gradient angles, to generate one of the first histogram amplitudes. Thus, the first HoG may be generated by accumulating the gradient amplitudes based on the at least one mapping mode to generate the first histogram amplitudes. A horizontal axis of the first HoG may represent intra prediction mode indices, and a vertical axis of the first HoG may represent accumulated strengths (e.g., first histogram amplitudes). In some implementation, the first HoG may be generated based on the gradient angles and the gradient amplitudes for selecting the intra angular modes. In addition, each of the first histogram amplitudes, included in the first HoG, may correspond to one of the intra angular modes having their respective intra prediction mode indices.

In some implementations, when the second gradient amplitude is generated, the second gradient amplitude may also be added to the first histogram amplitudes in the first HoG based on the predefined relationship between the gradient angles and the intra angular modes. In some implementations, although the gradient sources of the first gradient amplitude and the second gradient amplitude are different, the first gradient amplitude and the second gradient amplitude may be directly added to the first histogram amplitudes in the first HoG without further adjustments.

In some other implementations, since the gradient sources of the first gradient amplitude and the second gradient amplitude are different, the first gradient amplitude may be directly added to the first histogram amplitudes and the second gradient amplitude may be needed to be further adjusted. The adjusted gradient amplitude may then be added to the first histogram amplitudes in the first HoG.

In some implementations, the decoder module 124 may determine a magnitude of a block vector for the second set of template samples. The block vector may indicate a specific one of the at least one BV-guided reference block, associated with the second set of template samples, from the block unit. For example, as shown in FIG. 4B, the block vector of the BV-guided reference block 422 may indicate a top-left corner of the BV-guided reference block 422 from the top-left corner of the block unit 400. Thus, the block vector of the BV-guided reference block 422 may be determined based on the guiding vectors 4001 and 4112. In addition, the block vector of the BV-guided reference region 4210, neighboring the BV-guided reference block 421, may indicate a top-left corner of the BV-guided reference block 421 from the top-left corner of the block unit 400. Thus, the block vector of the BV-guided reference region 4210, neighboring the BV-guided reference block 421, may be determined based on the guiding vectors 4001 and 4111. Each of the at least one guiding region, included in the template regions and selected from the at least one BV-guided reference block and the at least one BV-guided reference regions, may be associated with and determined based on their respective block vectors.

The decoder module 124 may further determine a weighted parameter of the second gradient amplitude based on the magnitude of the block vector. For example, the decoder module 124 may determine all of the block vectors for the guiding regions. In some implementations, the number of the guiding regions may be equal to K and the number K may be a positive integer, greater than one. Thus, the magnitudes of the block vectors may be equal to M1, M2, . . . , and Mk. In some implementations, the weighted parameter W1 of the second gradient amplitude, determined based on the second set of template samples included in a first one of the guiding regions, may be calculated to be equal to 1−(M1/(M1+M2+ . . . +Mk)). In some implementations, the weighted parameter Wp of the second gradient amplitude, determined based on a specific set of template samples included in a P-th one of the guiding regions, may be equal to 1−(Mp/(M1+M2+ . . . +Mk)). In some implementations, the number P may be a positive integer which is less than K.

It should be understood that the determination of the weighted parameters, is not limited to the implementation disclosed above. Various rearrangements, modifications, and substitutions regarding the determination of the weighted parameters are possible without departing from the scope of the present disclosure.

The decoder module 124 may multiply the second gradient amplitude by the weighted parameter of the second gradient amplitude to generate a weighted amplitude. Thus, each of the gradient amplitudes, determined based on the at least one guiding region, may be multiplied by a corresponding one of the weighted parameters to generate multiple weighted amplitudes. The decoder module 124 may then add the weighted amplitude to the first histogram amplitudes of the first HoG.

In some implementations, when the second gradient amplitude is generated, the second gradient amplitude may be added to multiple second histogram amplitudes in multiple second HoGs. In some implementations, each of the at least one guiding region may correspond to a unique HoG. In other words, each of the at least one BV-guided reference block, included in the template regions, may correspond to a unique HoG, and each of the at least one BV-guided reference region, included in the template regions, may also correspond to a unique HoG. Thus, the number of the at least one guiding region, included in the template regions, may be equal to the number of the second HoG.

In some implementations, each of the at least one BV-guided reference region, included in the template regions, may correspond to a unique HoG. In some implementations, the template regions may include the at least one BV-guided reference block and the at least one BV-guided reference region. The second HoG, used for each of the at least one BV-guided reference region that is included in the template region, may be identical to the second HoG, used for a corresponding one of the at least one BV-guided reference block that is included in the template region. In other words, a specific BV-guided reference block and a specific BV-guided reference region, neighboring the specific BV-guided reference block, may correspond to the same second HoG. Thus, the number of the at least one BV-guided reference region, included in the template regions, may be equal to the number of the second HoG. In some other implementations, the template regions may include the at least one BV-guided reference region and each of the at least one BV-guided reference block may be excluded from the template regions.

In some implementations, before the first gradient amplitude is added to the first histogram amplitudes in the first HoG, the first gradient amplitude may be excluded from the cumulative sum of the first histogram amplitudes in the first HoG. After the first gradient amplitude is added to the first histogram amplitudes in the first HoG, the decoder module 124 may calculate and update, again, the cumulative sum of the first histogram amplitudes, including the first gradient amplitude.

In some implementations, before one of the second gradient amplitude and the weighted amplitude is added to the first histogram amplitudes of the first HoG, the one of the second gradient amplitude and the weighted amplitude may be excluded from the cumulative sum of the first histogram amplitudes in the first HoG. After the one of the second gradient amplitude and the weighted amplitude is added to the first histogram amplitudes of the first HoG, the decoder module 124 may calculate and update, again, the cumulative sum of the first histogram amplitudes, including the one of the second gradient amplitude and the weighted amplitude

In some implementations, before the second gradient amplitude is added to the second histogram amplitudes of the second HoG, the second gradient amplitude may be excluded from the cumulative sum of the second histogram amplitudes in the second HoG. After the second gradient amplitude is added to the second histogram amplitudes of the second HoG, the decoder module 124 may calculate and update, again, the cumulative sum of the second histogram amplitudes, including the second gradient amplitude.

Referring back to FIG. 3, at block 360, the decoder module 124 may compare the cumulative sum of the first histogram amplitudes with a first amplitude threshold. In some implementations, the first amplitude threshold may be determined based on the size parameter of the block unit. In some other implementations, the first amplitude threshold may be equal to a fixed value that is predefined in the decoder module 124 and the encoder module 114.

With reference to FIGS. 1 and 2, the decoder module 124 may determine the first amplitude threshold based on the size parameter of the block unit. Thus, the decoder module 124 may select the first amplitude threshold from multiple threshold candidates based on the size parameter of the block unit.

In some implementations, the first amplitude threshold may be determined based on only one of the block width Wb and the block height Hb of the block unit when the size parameter of the block unit is the one of the block width Wb and the block height Hb. In some implementations, the first amplitude threshold may be determined based on both the block width Wb and the block height Hb of the block unit. In some implementations, the first amplitude threshold may be determined based on one of the size product Wb×Hb, the size ratio (Wb/Hb), and the size ratio (Hb/Wb) when the size parameter of the block unit is the one of the size product Wb×Hb, the size ratio (Wb/Hb), and the size ratio (Hb/Wb). In some implementations, the first amplitude threshold may be determined based on the size pair (Wb, Hb) when the size parameter of the block unit is the size pair (Wb, Hb).

In some implementations, the first amplitude threshold may increase, or remain unchanged, when the size parameter of the block unit increases. In addition, the first amplitude threshold may decrease, or remain unchanged, when the size parameter of the block unit decreases. In some implementations, when the size parameter is one of the block width Wb, the block height Hb, the size product Wb×Hb, the size ratio (Wb/Hb), and the size ratio (Hb/Wb), the size parameter may be compared with a second size threshold. In some implementations, the second size threshold may be predefined in the decoder module 124 and the encoder module 114. In some implementations, the first amplitude threshold may be generated by multiplying the size product Wb×Hb by a multiplicative factor F. The multiplicative factor F may be a positive integer that is greater than 0.

In some implementations, the first amplitude threshold may be equal to a first threshold candidate when the size parameter of the block unit is equal to, or less than, the second size threshold. In addition, the first amplitude threshold may be equal to a second threshold candidate when the size parameter of the block unit is greater than the second size threshold. In some implementations, the second threshold candidate may be greater than the first threshold candidate, and the first and second threshold candidates may be positive integers. Thus, the second size threshold may be used to select the first amplitude threshold.

In some implementations, the decoder module 124 and the encoder module 114 may further have a third size threshold. In some implementations, the first amplitude threshold may be equal to the second threshold candidate when the size parameter of the block unit is equal to, or less than, the third size threshold and greater than the second size threshold. In addition, the first amplitude threshold may be equal to a third threshold candidate when the size parameter of the block unit is greater than the second and third size thresholds. In some implementations, the third threshold candidate may be a positive integer that is greater than the second threshold candidate. Thus, the first amplitude threshold may be equal to, or greater than, the second threshold candidate when the size parameter of the block unit is greater than the second size threshold.

In some implementations, the decoder module 124 may determine the first amplitude threshold, based on the size parameter of the block unit, by using a threshold table. In some implementations, the threshold table, including multiple threshold candidates, may be predefined in the decoder module 124 and the encoder module 114. Each of the threshold candidates, in the threshold table, may correspond to one of multiple size combinations, generated from multiple width candidates and one of multiple height candidates. The number of width candidates may be equal to a positive integer, such as five, six, seven, or eight, and the number of height candidates may also be equal to a positive integer, such as five, six, seven, or eight. In addition, each of the size combinations may correspond to one of the threshold candidates in the threshold table. When the decoder module 124 determines the first amplitude threshold by comparing the size parameter with the size combinations in the size table, the decoder module 124 may compare the size pair (Wb, Hb) with the size combinations.

In some implementations, after the cumulative sum of the first histogram amplitudes has been updated to include the first gradient amplitude, the decoder module 124 may compare the cumulative sum of the first histogram amplitudes with the first amplitude threshold. In some implementations, when the cumulative sum of the first histogram amplitudes is greater than, or equal to, the first amplitude threshold, the decoder module 124 may terminate filtering the template samples.

In some implementations, when the cumulative sum of the first histogram amplitudes is still less than the first amplitude threshold, the decoder module 124 may keep filtering the template samples to generate a new gradient amplitude. For example, the decoder module 124 may filter a third set of template samples, included in the template samples of the template regions, to generate a third template gradient. The decoder module 124 may then determine a third gradient amplitude and a third gradient angle by the above equations (5) and (6). In addition, the decoder module 124 may add the third gradient amplitude to the first histogram amplitudes of the first HoG based on the predefined relationship between the gradient angles and the intra angular modes. In some implementations, the decoder module 124 may further update the cumulative sum of the first histogram amplitudes. The decoder module 124 may then compare the updated cumulative sum of the first histogram amplitudes with the first amplitude threshold again for determining whether to keep, or to terminate, filtering the template samples. Thus, the gradient amplitudes calculated for each template sample may be sequentially and continuously accumulated until the cumulative sum may exceed the amplitude threshold.

In some implementations, the first set of template samples may, partially, overlap the third set of template samples. In some implementations, the first set of template samples may overlap the third set of template samples, except for one column or one row. For example, when the filter size of the gradient filter is 3×3, the size of a non-overlapping portion between the first and third sets of template samples may be 3×2. Thus, the number of template samples, included in the non-overlapping portion, may be equal to six. In addition, when the filter size of the gradient filter is 2×2, the size of the non-overlapping portion between the first and third sets of template samples may be 2×1. Thus, the number of template samples, included in the non-overlapping portion, may be equal to two.

In some implementations, the second gradient amplitude, generated based on the guiding regions of the template regions, may be added to the second histogram amplitudes of the second HoG. After the second gradient amplitude is added to the second HoG, the decoder module 124 may further compare the cumulative sum of the second histogram amplitudes with a second amplitude threshold.

In some implementations, the second amplitude threshold may be identical to the first amplitude threshold since a block size of the BV-guided blocks is identical to the block size of the block unit. In some implementations, the second amplitude threshold may be different from the first amplitude threshold. For example, the second amplitude threshold may be different from the first amplitude threshold when the second amplitude threshold is determined based on the block vector of the specific BV-guided reference block. In some implementations, the second amplitude threshold does not exist, since each of the second gradient amplitudes may be added to the first HoG.

In some implementations, after the cumulative sum of the second histogram amplitudes has been updated to include the second gradient amplitude, the decoder module 124 may compare the cumulative sum of the second histogram amplitudes with the second amplitude threshold. In some implementations, when the cumulative sum of the second histogram amplitudes is greater than, or equal to, the second amplitude threshold, the decoder module 124 may terminate filtering the template samples in the guiding regions.

In some implementations, when the cumulative sum of the second histogram amplitudes is still less than the second amplitude threshold, the decoder module 124 may keep filtering the template samples, included in the guiding regions, to generate a new gradient amplitude. In addition, the decoder module 124 may add the new gradient amplitude to the second histogram amplitudes of the second HoG based on the predefined relationship. In some implementations, the decoder module 124 may further update the cumulative sum of the second histogram amplitudes. The decoder module 124 may then compare the updated cumulative sum of the second histogram amplitudes with the second amplitude threshold again for determining whether to keep, or to terminate, filtering the template samples.

In some implementations, the neighboring regions of the template regions may include multiple neighboring lines. The number of neighboring lines may be equal to N. In some implementations, the number N may be a positive integer that is greater than one. For example, the number N may be equal to one of two, three, and four.

In some implementations, the decoder module 124 may add one to the number (e.g., N) of neighboring lines to update the template regions when all of the template samples have been filtered and the cumulative sum of the first histogram amplitudes is still less than the amplitude threshold. Thus, the number of neighboring lines may increase to N+1 and the neighboring lines may include a new neighboring line. Since the number of the neighboring lines, included in the neighboring regions of the template regions, increases, the number of template samples may also increase. Thus, the decoder module 124 may resume filtering the template samples to generate a new gradient amplitude.

For example, the decoder module 124 may filter a fourth set of template samples, included in the template samples of the updated template regions to generate a fourth template gradient. The decoder module 124 may then determine a fourth gradient amplitude and a fourth gradient angle by the above equations (5) and (6). In addition, the decoder module 124 may add the fourth gradient amplitude to the first histogram amplitudes of the first HoG based on the predefined relationship between the gradient angles and the intra angular modes. In some implementations, the decoder module 124 may further update the cumulative sum of the first histogram amplitudes. The decoder module 124 may then compare the updated cumulative sum of the first histogram amplitudes with the first amplitude threshold again for determining whether to keep, or to terminate, filtering the template samples. In some implementations, the fourth set of template samples may include the template samples in the new neighboring line.

Referring back to FIGS. 5A and 5B, the decoder module 124 may filter the template samples, included in the neighboring region 5000 that has three neighboring lines, to generate the first HoG. However, the decoder module 124 may add one to three to update the template regions when all of the template samples, included in the three neighboring lines, have been filtered and the cumulative sum of the first histogram amplitudes is still less than the amplitude threshold. Thus, the number of neighboring lines may increase to four. Thus, the decoder module 124 may resume filtering the template samples, included in the neighboring region 5000′ that has four neighboring lines, to update the first HoG.

Referring back to FIG. 3, at block 370, the decoder module 124 may reconstruct the block unit based on the first HoG when the cumulative sum of the first histogram amplitudes is greater than, or equal to, the amplitude threshold.

With reference to FIGS. 1 and 2, in some implementations, when the cumulative sum of the first histogram amplitudes in the first HoG is greater than, or equal to, the first amplitude threshold, the decoder module 124 may terminate filtering the template samples in the neighboring regions. In some other implementations, when the cumulative sum of the first histogram amplitudes in the first HoG is greater than, or equal to, the first amplitude threshold, the decoder module 124 may terminate filtering the template samples in the template regions. Thus, the decoder module 124 may select multiple intra prediction modes from the intra angular modes based on the first HoG. In some implementations, each of the first histogram amplitudes, included in the first HoG, may correspond to a unique intra angular mode.

Some of the intra angular modes may be selected to be the intra prediction modes based on the first histogram amplitudes of the first HoG. When the number of intra prediction modes is equal to M, M intra angular modes may be selected based on the top M gradient amplitudes of the first HoG. In some implementations, the number M may be a positive integer, e.g., two, three, four, five, and six. In one implementation, at least one of the non-angular modes in the intra default modes may be directly added to the intra prediction modes. For example, the non-angular modes may include the Planar mode and the DC mode.

In some implementations, when the cumulative sum of the second histogram amplitudes in the second HoG is greater than, or equal to, the second amplitude threshold, the decoder module 124 may terminate filtering the template samples in the guiding regions. Thus, the decoder module 124 may select the intra prediction modes from the intra angular modes based on the second HoG. In some implementations, each of the second histogram amplitudes, included in the second HoG, may correspond to a unique intra angular mode.

Some of the intra angular modes may be selected to be the intra prediction modes based on the second histogram amplitudes of the second HoG. When the number of intra prediction modes is equal to Q, Q intra angular modes may be selected based on the top Q gradient amplitudes of the second HoG. In some implementations, the number Q may be a positive integer, e.g., two, three, four, five, and six. In one implementation, at least one of the non-angular modes in the intra default modes may be directly added to the intra prediction modes.

In some implementations, the decoder module 124 may predict the block unit based on the intra prediction modes to generate multiple intra-predicted blocks. Each of the intra-predicted blocks may be generated based on a corresponding one of the intra prediction modes. In some implementations, the decoder module 124 may reconstruct the block unit by weightedly combining the intra-predicted blocks to generate a weighted prediction block.

Thus, in some implementations, the block unit may be reconstructed based on the first HoG when the cumulative sum of the first histogram amplitudes is greater than, or equal to, the first amplitude threshold. In some other implementations, the block unit may be reconstructed based on the first and second HoGs when the cumulative sum of the first histogram amplitudes is greater than, or equal to, the first amplitude threshold and the cumulative sum of the second histogram amplitudes is greater than, or equal to, the second amplitude threshold.

In some implementations, since each of the at least one BV-guided reference region, included in the template regions, may correspond to a unique HoG, the video data may further include at least one histogram index. The histogram index may be used for selecting at least one of the first HoG and the second HoGs. The decoder module 124 may determine the intra prediction modes based on the at least selected one of the first HoG and the second HoGs.

The decoder module 124 may determine multiple residual components of a residual block from the bitstream for the block unit and may add the residual components to the weighted prediction block to reconstruct the chroma block unit. The decoder module 124 may reconstruct all of the other block units in the image frame to reconstruct the image frame and the video.

Referring back to FIG. 3, after reconstructing the block unit (e.g., based on at least one of the first and second HoGs), the method/process 300 may end.

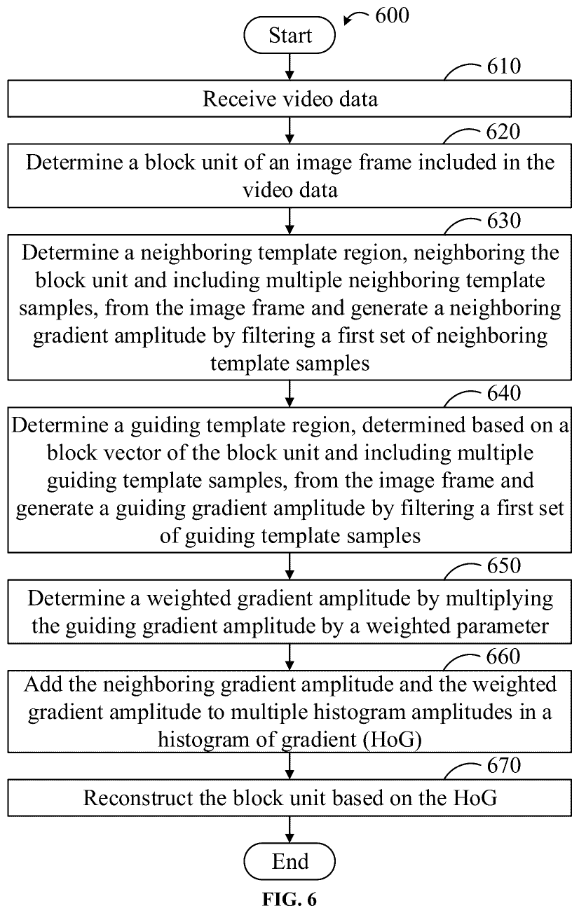

FIG. 6 is a flowchart illustrating a method/process 600 for decoding and/or encoding video data by an electronic device, in accordance with one or more example implementations of this disclosure. The method/process 600 is an example implementation, as there may be a variety of mechanisms of decoding the video data.

The method/process 600 may be performed by an electronic device using the configurations illustrated in FIGS. 1 and/or 2, where various elements of these figures may be referenced to describe the method/process 600. Each block illustrated in FIG. 6 may represent one or more processes, methods, or subroutines performed by an electronic device.

The order in which the blocks appear in FIG. 6 is for illustration only, and may not be construed to limit the scope of the present disclosure, thus the order may be different from what is illustrated. Additional blocks may be added or fewer blocks may be utilized without departing from the scope of the present disclosure.

With reference to FIG. 6, at block 610, the method/process 600 may start by receiving (e.g., via the decoder module 124, as shown in FIG. 2) the video data. The video data, received by the decoder module 124, may include a bitstream.

With reference to FIGS. 1 and 2, the second electronic device 120 may receive the bitstream from an encoder, such as the first electronic device 110 (or other video providers), via the second interface 126.

At block 620, the decoder module 124 may determine a block unit of an image frame included in the video data.

With reference to FIGS. 1 and 2, the decoder module 124 may determine the image frames, included in the bitstream, when the video data, received by the decoder module 124, includes the bitstream. The determination of the block unit, performed at block 620 of the method 600, may be identical to the determination of the block unit, performed at block 320 of the method 300.

Referring back to FIG. 6, at block 630, the decoder module 124 may determine a neighboring template region, neighboring the block unit and including multiple neighboring template samples, from the image frame and generate a neighboring gradient amplitude by filtering a first set of neighboring template samples. In some implementations, the first set of neighboring template samples may be included in the neighboring template samples of the neighboring template region.

With reference to FIGS. 1 and 2, the decoder module 124 may determine multiple neighboring regions, neighboring the block unit, for determining the neighboring template region. For example, as shown in FIG. 4A, the decoder module 124 may determine the neighboring regions 401-403, neighboring the block unit 400, as the neighboring template region. In addition, as shown in FIG. 4B, the decoder module 124 may determine the neighboring region 4000, neighboring the block unit 400, as the neighboring template region from the current frame 40.

In some implementations, the neighboring template region may include the neighboring template samples. The neighboring template region may be predicted and/or reconstructed prior to the prediction and/or the reconstruction of the block unit. Thus, the neighboring template samples, included in the neighboring template region, may be multiple reconstructed samples, included in the neighboring template region, when the block unit is being predicted and/or reconstructed.

The decoder module 124 may filter multiple sets of neighboring template samples, included in the neighboring template region, to generate multiple neighboring template gradients by using a gradient filter. For example, the decoder module 124 may filter the first set of neighboring template samples to generate one neighboring gradient amplitude.

In some implementations, the gradient filter may be the Sobel filter. The neighboring template gradients may be generated by filtering the neighboring template samples based on the above filtering equations (1) and (2) or the above filtering equations (3) and (4). For example, as shown in FIG. 5A, when the filter size of the gradient filter is 3×3, a size of a specific set of neighboring template samples, included in a first set region 5010 or a third set region 5030, may be 3×3. In some implementations, as shown in FIG. 5B, when the filter size of the gradient filter is 2× 2, a size of a specific set of neighboring template samples, included in a second set region 5020 or a fourth set region 5040, may be 2× 2.

In some implementations, the filter size of the gradient filter may be selected based on a size parameter of the block unit 500. In some implementations, the decoder module 124 may select the gradient filter from multiple filter candidates based on the size parameter of the block unit 500. The determination of the gradient filter, used for the neighboring template region and performed at block 630 of the method 600, may be identical to the determination of the gradient filter, used for the neighboring region and performed at block 340 of the method 300.

The neighboring template gradients of the filtered template samples may be further computed to generate multiple neighboring gradient amplitudes and multiple neighboring gradient angles. Thus, the neighboring template region may be filtered by using the gradient filter for generating the neighboring gradient angles and the neighboring gradient amplitudes. The neighboring gradient amplitudes Amp and the neighboring gradient angles Angle may be derived by the above equations (5) and (6).

The generation of the neighboring template gradients, performed at block 630 of the method 600, may be identical to the determination of the template gradients, generated based on the neighboring region and performed at block 340 of the method 300.

Referring back to FIG. 6, at block 640, the decoder module 124 may determine a guiding template region, determined based on a block vector of the block unit and including multiple guiding template samples, from the image frame and generate a guiding gradient amplitude by filtering a first set of guiding template samples. In some implementations, the first set of guiding template samples may be included in the guiding template samples of the guiding template region.

With reference to FIGS. 1 and 2, the decoder module 124 may determine at least one guiding template region that is determined from multiple block-vector-guided (BV-guided) regions. The BV-guided regions may further include at least one BV-guided reference block and at least one BV-guided reference region. Each of the at least one BV-guided reference region may neighbor a corresponding one of the at least one BV-guided reference block. In some implementations, the BV-guided regions may be different from the neighboring template region.

In some implementations, the at least one guiding template region may be selected only from the at least one BV-guided reference region. In some other implementations, the at least one guiding template region may be selected from the BV-guided regions, including the at least one BV-guided reference block and the at least one BV-guided reference region.

For example, as shown in FIG. 4B, the decoder module 124 may determine the BV-guided reference blocks 411, 412, 421, 422, and 431 based on five guiding vectors 4001, 4002, 4011, 4012, and 4221. In addition, the decoder module 124 may further determine the BV-guided reference regions 4110, 4120, 4210, 4220, and 4310, neighboring a corresponding one of the BV-guided reference blocks 411, 412, 421, 422, and 431. The determination of the guiding template region, performed at block 640 of the method 600, may be identical to the determination of the template regions, generated based on the guiding region and performed at block 330 of the method 300.

In some implementations, the at least one BV-guided reference region, neighboring the at least one BV-guided reference block may have the same shape and size as the neighboring template region. In some implementations, each of the guiding template regions may include the guiding template samples. The at least one BV-guided reference block and the at least one BV-guided reference region may be predicted and/or reconstructed prior to the prediction and/or the reconstruction of the block unit. Thus, the guiding template samples, included in the guiding template regions, may be multiple reconstructed samples, included in the guiding template regions, when the block unit is being predicted and/or reconstructed.

The decoder module 124 may filter multiple sets of guiding template samples, included in the guiding template regions, to generate multiple guiding template gradients by using the gradient filter. For example, the decoder module 124 may filter a first set of guiding template samples to generate one guiding gradient amplitude.

In some implementations, the gradient filter may be the Sobel filter. The guiding template gradients may be generated by filtering the guiding template samples based on the above filtering equations (1) and (2) or the above filtering equations (3) and (4). The determination of the gradient filter, used for the guiding template region and performed at block 640 of the method 600, may be identical to the determination of the gradient filter, used for the guiding region and performed at block 340 of the method 300.

The guiding template gradients of the filtered template samples may be further computed to generate multiple guiding gradient amplitudes and multiple guiding gradient angles. Thus, the guiding template regions may be filtered by using the gradient filter for generating the guiding gradient angles and the guiding gradient amplitudes. The guiding gradient amplitudes Amp and the guiding gradient angles Angle may be derived by the above equations (5) and (6).

The generation of the guiding template gradients performed at block 640 of the method 600 may be identical to the determination of the template gradients, generated based on the guiding region and performed at block 340 of the method 300.

Referring back to FIG. 6, at block 650, the decoder module 124 may determine a weighted gradient amplitude by multiplying the guiding gradient amplitude by a weighted parameter.

With reference to FIGS. 1 and 2, the decoder module 124 may determine a magnitude of a guiding block vector for the first set of guiding template samples. The guiding block vector may indicate a specific one of the at least one BV-guided reference block, associated with the first set of guiding template samples, from the block unit. For example, as shown in FIG. 4B, the guiding block vector of the BV-guided reference block 422 may indicate a top-left corner of the BV-guided reference block 422 from the top-left corner of the block unit 400. Thus, the guiding block vector of the BV-guided reference block 422 may be determined based on the guiding vectors 4001 and 4112. In addition, the guiding block vector of the BV-guided reference region 4210, neighboring the BV-guided reference block 421, may indicate a top-left corner of the BV-guided reference block 421 from the top-left corner of the block unit 400. Thus, the guiding block vector of the BV-guided reference region 4210, neighboring the BV-guided reference block 421, may be determined based on the guiding vectors 4001 and 4111. Each of the at least one guiding template region, selected from the at least one BV-guided reference block and the at least one BV-guided reference region, may be associated with and determined based on their respective guiding block vectors.

In some implementations, the decoder module 124 may further determine the weighted parameter of the guiding gradient amplitude based on the magnitude of the guiding block vector. For example, the decoder module 124 may determine all of the guiding block vectors for the guiding template regions when the number of the guiding template regions is equal to K which is a positive integer, greater than one. Thus, the magnitudes of the guiding block vectors may be equal to M1, M2, . . . , and Mk.

In some implementations, the weighted parameter W1 of the guiding gradient amplitude, determined based on the first set of guiding template samples included in the guiding template region, may be calculated to be equal to 1−(M1/(M1+M2+ . . . +Mk)). In some implementations, the weighted parameter Wp of the guiding gradient amplitude, determined based on a specific set of guiding template samples, included in a P-th one of the guiding template regions, may be equal to 1−(Mp/(M1+M2+ . . . +Mk)). In some implementations, the number P may be a positive integer which is less than K.

It should be understood that the determination of the weighted parameters, is not limited to the implementation disclosed above. Various rearrangements, modifications, and substitutions regarding the determination of the weighted parameters are possible without departing from the scope of the present disclosure.

The decoder module 124 may multiply the guiding gradient amplitude by the weighted parameter of the guiding gradient amplitude to generate a weighted gradient amplitude. Thus, each of the guiding gradient amplitudes, determined based on the at least one guiding template region, may be multiplied by a corresponding one of the weighted parameters to generate multiple weighted gradient amplitudes.

Referring back to FIG. 6, at block 660, the decoder module 124 may add the neighboring gradient amplitude and the weighted gradient amplitude to multiple histogram amplitudes in a histogram of gradient (HoG).

With reference to FIGS. 1 and 2, the decoder module 124 may determine the HoG based on multiple neighboring combinations of the neighboring gradient amplitudes and the neighboring gradient angles and multiple guiding combinations of the weighted gradient amplitudes and guiding gradient angles. In addition, the decoder module 124 may determine the HoG based on the neighboring combinations and the guiding combinations to generate the histogram amplitudes in the HoG. In some implementations, the weighted gradient amplitudes may be added to the HoG after each neighboring gradient amplitude has been added. In some other implementations, the neighboring template gradients and the guiding template gradients may, respectively, be calculated one by one without interfering with each other. Subsequently, the neighboring gradient amplitudes and the weighted gradient amplitudes may, respectively, be added to the HoG.

A predefined relationship between multiple gradient angles (e.g., the neighboring gradient angles and the guiding gradient angles) and multiple intra angular modes may be predefined in the first electronic device 110 and the second electronic device 120. For example, the relationship may be stored in form of a look-up table (LUT), an equation, or a combination thereof. The intra angular modes may be included in multiple intra default modes. The intra default modes may further include multiple non-angular modes. The non-angular modes may include a Planar mode and a DC mode.

The intra default modes, used at block 660 of the method 600, may be identical to the intra default modes, used at block 350 of the method 300. The predefined relationship, used at block 660 of the method 600, may be identical to the predefined relationship, used at blocks 350 and 360 of the method 300. Thus, the mapping method between the intra angular modes and the gradient angles, used at block 660 of the method 600, may also be identical to the mapping method between the intra angular modes and the gradient angles, used at blocks 350 and 360 of the method 300.

Each of the neighboring gradient amplitudes may correspond to a corresponding one of the neighboring gradient angles. Thus, when at least one neighboring mapping mode is determined based on the neighboring gradient angles, the decoder module 124 may generate the HoG by accumulating the neighboring gradient amplitudes based on the at least one mapping mode. For example, when two neighboring gradient angles, different from each other, correspond to the same intra angular mode, two neighboring gradient amplitudes of the two neighboring gradient angles may be accumulated for one mapping mode, corresponding to the two neighboring gradient angles, to generate one of the histogram amplitudes. Thus, the HoG may be generated by accumulating the neighboring gradient amplitudes based on the at least one mapping mode to generate the histogram amplitudes. A horizontal axis of the HoG may represent intra prediction mode indices, and a vertical axis of the HoG may represent accumulated strengths (e.g., histogram amplitudes). In some implementation, the cumulative sum of the histogram amplitudes in the HoG may be generated based on the neighboring gradient angles and the neighboring gradient amplitudes for selecting the intra angular modes. In addition, each of the histogram amplitudes, included in the HoG, may correspond to one of the intra angular modes having their respective intra prediction mode indices.

Each of the weighted gradient amplitudes, generated based on the guiding gradient amplitudes, may correspond to a corresponding one of the guiding gradient angles. Thus, when at least one guiding mapping mode is determined based on the guiding gradient angles, the decoder module 124 may generate the HoG by further accumulating the weighted gradient amplitudes with the accumulated neighboring gradient amplitudes based on the at least one guiding mapping mode. Thus, the HoG may be generated by further accumulating the weighted gradient amplitudes with the accumulated neighboring gradient amplitudes to generate the histogram amplitudes. In some implementation, the cumulative sum of the histogram amplitudes in the HoG may be generated further based on the weighted gradient amplitudes for selecting the intra angular modes.

In some implementations, each of the neighboring gradient amplitudes and the weighted gradient amplitudes may be directly added to the histogram amplitudes of the HoG to generate the cumulative sum of the histogram amplitudes in the HoG without performing an early termination determination. In some other implementations, the neighboring gradient amplitudes may be directly added to the histogram amplitudes of the HoG. The weighted gradient amplitudes may then be added to the histogram amplitudes of the HoG, one by one, to update the cumulative sum of the histogram amplitudes in the HoG, while performing an early termination determination.

In some implementation, after a first one of the weighted gradient amplitudes has been added to the histogram amplitudes of the HoG, the decoder module 124 may update the cumulative sum of the histogram amplitudes in the HoG. The decoder module 124 may then compare the updated cumulative sum of the histogram amplitudes in the HoG with an amplitude threshold. In some implementations, when the updated cumulative sum of the histogram amplitudes is greater than, or equal to, the amplitude threshold, the decoder module 124 may terminate filtering the guiding template samples.

In some implementations, when the updated cumulative sum of the histogram amplitudes is still less than the amplitude threshold, the decoder module 124 may keep filtering the guiding template samples to generate a second one of the weighted gradient amplitudes. For example, the decoder module 124 may filter a second set of guiding template samples, included in the guiding template samples of the guiding template regions, to generate a new template gradient. The decoder module 124 may then determine a new gradient amplitude and a new gradient angle by the above equations (5) and (6), and determine the second weighted gradient amplitude based on the new gradient amplitude

In addition, the decoder module 124 may add the second weighted gradient amplitude to the histogram amplitudes in the HoG based on the predefined relationship. In some implementations, the decoder module 124 may further update the cumulative sum of the histogram amplitudes again. The decoder module 124 may then compare the updated cumulative sum of the histogram amplitudes with the amplitude threshold again for determining whether to keep filtering the guiding template samples or to terminate filtering the guiding template samples. Thus, the weighted gradient amplitudes calculated for each guiding template sample may be sequentially and continuously accumulated until the cumulative sum may exceed the amplitude threshold.

In some other implementation, when a specific one of the neighboring gradient amplitude has been added to the histogram amplitudes of the HoG, the decoder module 124 may update the cumulative sum of the histogram amplitudes in the HoG. The decoder module 124 may then compare the updated cumulative sum of the histogram amplitudes in the HoG with the amplitude threshold. In some implementations, when the updated cumulative sum of the histogram amplitudes is greater than, or equal to, the amplitude threshold, the decoder module 124 may terminate filtering the neighboring template samples. In addition, when the updated cumulative sum of the histogram amplitudes is still less than the amplitude threshold, the decoder module 124 may keep filtering the neighboring template samples to generate a second one of the neighboring gradient amplitudes. Thus, the neighboring gradient amplitudes calculated for each neighboring template sample may be sequentially and continuously accumulated until the cumulative sum may exceed the amplitude threshold.

The determination of the amplitude threshold at block 660 of the method 600 may be identical to the determination of the first amplitude threshold at block 360 of the method 300.

Referring back to FIG. 3, at block 670, the decoder module 124 may reconstruct the block unit based on the HoG.

With reference to FIGS. 1 and 2, in some implementations, the decoder module 124 may start adding the weighted gradient amplitudes to the HoG and performing the early termination determination after all of the neighboring gradient amplitudes have been added. Thus, when the cumulative sum of the histogram amplitudes in the HoG is greater than, or equal to, the amplitude threshold, the decoder module 124 may terminate filtering the guiding template samples in the guiding template regions.

In some other implementation, the decoder module 124 may perform the early termination determination for a corresponding neighboring gradient amplitude immediately after each neighboring gradient amplitude is added. Thus, when the cumulative sum of the histogram amplitudes in the HoG is greater than, or equal to, the amplitude threshold, the decoder module 124 may terminate filtering the neighboring template samples in the neighboring template regions. In addition, the decoder module 124 may then start adding the weighted gradient amplitudes to the HoG and performing the early termination determination for the weighted gradient amplitudes after all of the neighboring gradient amplitudes have been added. Thus, when the cumulative sum of the histogram amplitudes in the HoG is greater than, or equal to, the amplitude threshold, the decoder module 124 may terminate filtering the guiding template samples in the guiding template regions.

In some other implementations, the neighboring template gradients and the guiding template gradients may, respectively, be calculated one by one without interfering with each other. Subsequently, the neighboring gradient amplitudes and the weighted gradient amplitudes may, respectively, be added to the HoG. Thus, when the cumulative sum of the histogram amplitudes in the HoG is greater than, or equal to, the amplitude threshold, the decoder module 124 may, simultaneously, terminate filtering the neighboring template samples in the neighboring template regions and the guiding template samples in the guiding template regions.

In some implementations, the decoder module 124 may select multiple intra prediction modes from the intra angular modes based on the HoG after the filtering is terminated. In some implementations, each of the histogram amplitudes, included in the HoG, may correspond to a unique intra angular mode. Some of the intra angular modes may be selected to be multiple intra prediction modes based on the histogram amplitudes of the HoG. When the number of intra prediction modes is equal to M, M intra angular modes may be selected based on the top M gradient amplitudes of the HoG. In some implementations, the number M may be a positive integer, e.g., two, three, four, five, and six. In one implementation, at least one of the non-angular modes in the intra default modes may be directly added to the intra prediction modes. For example, the non-angular modes may include the Planar mode and the DC mode.

In some implementations, the decoder module 124 may predict the block unit based on the intra prediction modes to generate multiple intra-predicted blocks. Each of the intra-predicted blocks may be generated based on a corresponding one of the intra prediction modes. In some implementations, the decoder module 124 may reconstruct the block unit by weightedly combining the intra-predicted blocks to generate a weighted prediction block. Thus, in some implementations, the block unit may be reconstructed based on the HoG when the cumulative sum of the histogram amplitudes is greater than, or equal to, the amplitude threshold.

In some implementations, since each of the at least one BV-guided reference region, included in the guiding template regions, may be used to generate the guiding template gradients, the video data may further include at least one region index. The region index may be used for selecting one of the guiding template regions. The decoder module 124 may determine the selected guiding template regions based on the at least one region index and filter the guiding template samples, included in the selected guiding template regions. Thus, the decoder module 124 may ignore the unselected guiding template regions so as not to filter the guiding template samples, included in the unselected guiding template regions.

The decoder module 124 may determine multiple residual components of a residual block from the bitstream for the block unit and may add the residual components to the weighted prediction block to reconstruct the chroma block unit. The decoder module 124 may reconstruct all of the other block units in the image frame to reconstruct the image frame and the video.

Referring back to FIG. 6, after reconstructing the block unit (e.g., based on the HoG), the method/process 600 may end.

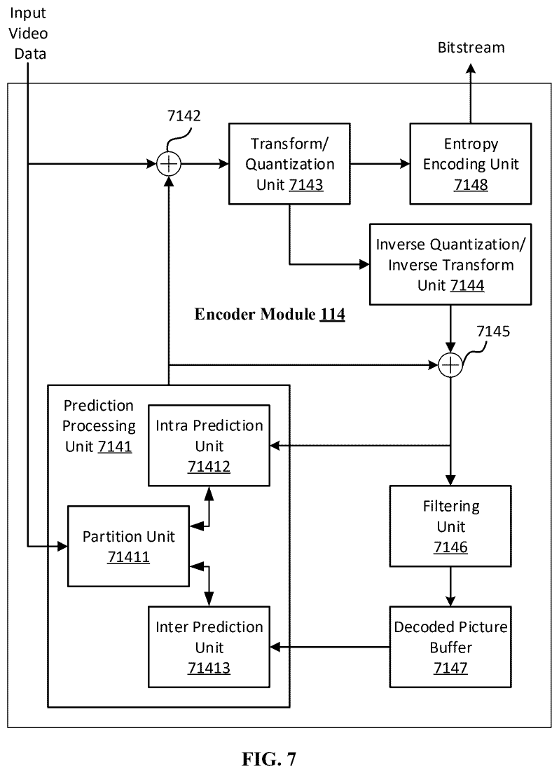

FIG. 7 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 7141), at least a first summer (e.g., a first summer 7142) and a second summer (e.g., a second summer 7145), a transform/quantization processor (e.g., a transform/quantization unit 7143), an inverse quantization/inverse transform processor (e.g., an inverse quantization/inverse transform unit 7144), a filter (e.g., a filtering unit 7146), a decoded picture buffer (e.g., a decoded picture buffer 7147), and an entropy encoder (e.g., an entropy encoding unit 7148). The prediction processing unit 7141 of the encoder module 114 may further include a partition processor (e.g., a partition unit 71411), an intra prediction processor (e.g., an intra prediction unit 71412), and an inter prediction processor (e.g., an inter prediction unit 71413). The encoder module 114 may receive the source video and encode the source video to output a bitstream.

The encoder module 114 may receive source video including multiple image frames and then divide the image frames based on a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 7141 may receive a current image block of a specific one of the image frames. The current image block may be the luminance block or one of the chrominance blocks in the specific image frame.

The partition unit 71411 may divide the current image block into multiple block units. The intra prediction unit 71412 may perform intra-predictive coding of a current block unit relative to one or more neighboring blocks in the same frame, as the current block unit, in order to provide spatial prediction. The inter prediction unit 71413 may perform inter-predictive coding of the current block unit relative to one or more blocks in one or more reference image blocks to provide temporal prediction.

The prediction processing unit 7141 may select one of the coding results generated by the intra prediction unit 71412 and the inter prediction unit 71413 based on a mode selection method, such as a cost function. The mode selection method may be a rate-distortion optimization (RDO) process.

The prediction processing unit 7141 may determine the selected coding result and provide a predicted block corresponding to the selected coding result to the first summer 7142 for generating a residual block and to the second summer 7145 for reconstructing the encoded block unit. The prediction processing unit 7141 may further provide syntax elements, such as motion vectors, intra-mode indicators, partition information, and/or other syntax information, to the entropy encoding unit 7148.

The intra prediction unit 71412 may intra-predict the current block unit. The intra prediction unit 71412 may determine an intra prediction mode directed toward a reconstructed sample neighboring the current block unit in order to encode the current block unit.

The intra prediction unit 71412 may encode the current block unit using various intra prediction modes. The intra prediction unit 71412 of the prediction processing unit 7141 may select an appropriate intra prediction mode from the selected modes. The intra prediction unit 71412 may encode the current block unit using a cross-component prediction mode to predict one of the two chroma components of the current block unit based on the luma components of the current block unit. The intra prediction unit 71412 may predict a first one of the two chroma components of the current block unit based on the second of the two chroma components of the current block unit.

The inter prediction unit 71413 may inter-predict the current block unit as an alternative to the intra prediction performed by the intra prediction unit 71412. The inter prediction unit 71413 may perform motion estimation to estimate motion of the current block unit for generating a motion vector.

The motion vector may indicate a displacement of the current block unit within the current image block relative to a reference block unit within a reference image block. The inter prediction unit 71413 may receive at least one reference image block stored in the decoded picture buffer 7147 and estimate the motion based on the received reference image blocks to generate the motion vector.

The first summer 7142 may generate the residual block by subtracting the prediction block determined by the prediction processing unit 7141 from the original current block unit. The first summer 7142 may represent the component or components that perform this subtraction.

The transform/quantization unit 7143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 7143 may perform a scan of the matrix including the quantized transform coefficients. Alternatively, the entropy encoding unit 7148 may perform the scan.

The entropy encoding unit 7148 may receive multiple syntax elements from the prediction processing unit 7141 and the transform/quantization unit 7143, including a quantization parameter, transform data, motion vectors, intra modes, partition information, and/or other syntax information. The entropy encoding unit 7148 may encode the syntax elements into the bitstream.

The entropy encoding unit 7148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 7144 may apply inverse quantization and inverse transformation to reconstruct the residual block in the pixel domain for later use as a reference block. The second summer 7145 may add the reconstructed residual block to the prediction block provided by the prediction processing unit 7141 in order to produce a reconstructed block for storage in the decoded picture buffer 7147.

The filtering unit 7146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 7145.

The decoded picture buffer 7147 may be a reference picture memory that stores the reference block to be used by the encoder module 714 to encode video, such as in intra-coding or inter-coding modes. The decoded picture buffer 7147 may include a variety of memory devices, such as DRAM (e.g., including SDRAM), MRAM, RRAM, or other types of memory devices. The decoded picture buffer 7147 may be on-chip with other components of the encoder module 114 or off-chip relative to those components.

The method/process 300 for decoding and/or encoding video data may be performed by the first electronic device 110. With reference to FIGS. 1 and 7, at block 310, the method/process 300 may start by the encoder module 114 receiving the video data. The video data received by the encoder module 114 may be a video.

At block 320, the encoder module 114 may determine a block unit of an image frame included in the video data. With reference to FIGS. 1 and 7, the encoder module 114 may determine the image frames from the video. A current frame may be one of the image frames. The encoder module 114 may further divide the current frame to determine the block unit. In some implementations, the encoder module 114 may divide the current frame to generate multiple CTUs, and may further divide a current CTU, included in the CTUs, to generate multiple divided blocks and to determine the block unit from the divided blocks.

In some implementations, a partitioning structure of the image frame, determined by the encoder module 114, may be identical to a partitioning structure of the image frame, determined by the decoder module 124. Thus, a block location and the block size Wb×Hb of the block unit, determined by the encoder module 114, may be identical to those determined by the decoder module 124.

At block 330, the encoder module 114 may determine multiple template regions, including multiple template samples, from the image frame. With reference to FIGS. 1 and 7, the method and procedure, used by the encoder module 114 for determining the template regions, may be identical to those used by the decoder module 124. Thus, a neighboring region and at least one guiding region, each included in the template regions that is determined by the encoder module 114, may be identical to those determined by the decoder module 124.

At block 340, the encoder module 114 may generate a first gradient amplitude by filtering a first set of template samples, included in the template samples. With reference to FIGS. 1 and 7, the method and procedure, used by the encoder module 114 for determining the gradient amplitudes, may be identical to those used by the decoder module 124. Thus, the gradient filter, determined by the encoder module 114, may be identical to that determined by the decoder module 124. In addition, the gradient amplitudes and the gradient angles, determined by the encoder module 114, may be identical to those determined by the decoder module 124.

At block 350, the encoder module 114 may add the first gradient amplitude to multiple first histogram amplitudes in a first histogram of gradient (HoG). In addition, the encoder module 114 may further calculate a cumulative sum of the first histogram amplitudes. With reference to FIGS. 1 and 7, the method and procedure, used by the encoder module 114 for determining the histogram amplitudes in the HoGs, may be identical to those used by the decoder module 124. Thus, the cumulative sum of the histogram amplitudes, calculated by the encoder module 114, may be identical to that calculated by the decoder module 124.

At block 360, the encoder module 114 may compare the cumulative sum of the first histogram amplitudes with a first amplitude threshold. In some implementations, the first amplitude threshold may be determined based on the size parameter of the block unit. In some other implementations, the first amplitude threshold may be equal to a fixed value that is predefined in the decoder module 124 and the encoder module 114.

With reference to FIGS. 1 and 7, the method and procedure, used by the encoder module 114 for determining the comparison, may be identical to those used by the decoder module 124. In addition, the determination of the amplitude threshold, performed by the encoder module 114, may be identical to that performed by the decoder module 124.

At block 370, the encoder module 114 may reconstruct the block unit based on the first HoG when the cumulative sum of the first histogram amplitudes is greater than, or equal to, the amplitude threshold. With reference to FIGS. 1 and 7, the encoder module 114 may predict the block unit based on the first HoG when the cumulative sum of the first histogram amplitudes is greater than, or equal to, the amplitude threshold. The method and procedure, used by the encoder module 114 for generating the weighted prediction block, may be identical to those used by the decoder module 124.

In some implementations, the encoder module 114 may generate the weighted prediction block only based on the first HoG. In some implementations, the encoder module 114 may generate the weighted prediction block based on the first HoG and all of the second HoGs. In some implementations, the encoder module 114 may generate the weighted prediction block based on the first HoG and one of the second HoGs. In some other implementations, the encoder module 114 may generate the weighted prediction block only based on one of the second HoGs. In other words, the encoder module 114 may generate multiple weighted prediction blocks based on at least one of the first HoG and the second HoGs.

In addition, the encoder module 114 may predict the block unit based on other prediction modes to generate multiple prediction blocks. The encoder module 114 may select one of the prediction blocks based on a mode selection method, such as a cost function. The mode selection method may be an RDO process, a Sum of Absolute Difference (SAD) process, a Sum of Absolute Transformed Difference (SATD) process, a Mean Absolute Difference (MAD) process, a Mean Squared Difference (MSD) process, and a Structural SIMilarity (SSIM) process. The encoder module 114 may provide the selected coding result to the first summer 7142 for generating a residual block and to the second summer 7145 for reconstructing the encoded block unit. The reconstruction of the block unit by the encoder module 114 may be identical to the reconstruction of the block unit by the decoder module 124.

The encoder module 114 may further encode the syntax elements into a bitstream, for transmitting to the decoder module 124. The syntax elements of the block unit may be used to determine a selected prediction candidate corresponding to the selected prediction block. In some implementations, the syntax elements, associated with the block unit, may further include multiple partition indications generated based on the partitioning of the block unit (e.g., based on any video coding standard).

In some implementations, when one of the weighted prediction blocks is selected to predict and/or reconstruct the block unit, the encoder module 114 may further provide syntax elements, such as a histogram index, included in the bitstream for transmitting to the decoder module 124. In some implementations, the histogram index of the block unit may be a block-level syntax element for selecting at least one of the first HoG and the second HoGs.

Referring back to FIG. 3, after reconstructing the block unit (e.g., based on the at least one of the first HoG and the second HoGs), the method/process 300 for the encoder module 114 may then end.

The method/process 600 for decoding and/or encoding video data may be performed by the first electronic device 110. With reference to FIGS. 1 and 7, at block 310, the method/process 600 may start by the encoder module 114 receiving the video data. The video data received by the encoder module 114 may be a video.

At block 620, the encoder module 114 may determine a block unit of an image frame included in the video data. With reference to FIGS. 1 and 7, the encoder module 114 may determine the image frames from the video. A current frame may be one of the image frames. The encoder module 114 may further divide the current frame to determine the block unit. In some implementations, the encoder module 114 may divide the current frame to generate multiple CTUs, and may further divide a current CTU, included in the CTUs, to generate multiple divided blocks and to determine the block unit from the divided blocks.

In some implementations, a partitioning structure of the image frame, determined by the encoder module 114, may be identical to a partitioning structure of the image frame, determined by the decoder module 124. Thus, a block location and the block size Wb×Hb of the block unit, determined by the encoder module 114, may be identical to those determined by the decoder module 124.

At block 630, the encoder module 114 may determine a neighboring template region, neighboring the block unit and including multiple neighboring template samples, from the image frame and generate a neighboring gradient amplitude by filtering a first set of neighboring template samples. With reference to FIGS. 1 and 7, the method and procedure, used by the encoder module 114 for determining the neighboring gradient amplitudes, may be identical to those used by the decoder module 124. In addition, the neighboring template region, determined by the encoder module 114, may be identical to that determined by the decoder module 124.

At block 640, the encoder module 114 may determine a guiding template region, determined based on a block vector of the block unit and including multiple guiding template samples, from the image frame and generate a guiding gradient amplitude by filtering a first set of guiding template samples. With reference to FIGS. 1 and 7, the method and procedure, used by the encoder module 114 for determining the guiding gradient amplitudes, may be identical to those used by the decoder module 124. Thus, the guiding template regions, determined by the encoder module 114, may be identical to those determined by the decoder module 124.

At block 650, the encoder module 114 may determine a weighted gradient amplitude by multiplying the guiding gradient amplitude by a weighted parameter. With reference to FIGS. 1 and 7, the method and procedure, used by the encoder module 114 for determining the weighted gradient amplitude, may be identical to those used by the decoder module 124. In addition, the determination of the weighted parameter, performed by the encoder module 114, may be identical to that performed by the decoder module 124.

At block 660, the encoder module 114 may add the neighboring gradient amplitude and the weighted gradient amplitude to multiple histogram amplitudes in a histogram of gradient (HoG). With reference to FIGS. 1 and 7, the method and procedure, used by the encoder module 114 for determining the HoG, may be identical to those used by the decoder module 124. In addition, the determination of the histogram amplitudes, performed by the encoder module 114, may be identical to that performed by the decoder module 124.

At block 670, the encoder module 114 may reconstruct the block unit based on the HoG. With reference to FIGS. 1 and 7, the encoder module 114 may predict the block unit based on the HoG when the cumulative sum of the histogram amplitudes is greater than, or equal to, the amplitude threshold. The method and procedure, used by the encoder module 114 for generating the weighted prediction block, may be identical to those used by the decoder module 124.

In some implementations, the encoder module 114 may generate the weighted prediction block based on the HoG. In some implementations, the HoG may be generated only based on the neighboring template region. In some implementations, the HoG may be generated based on the neighboring template region and all of the guiding template regions. In some implementations, the HoG may be generated based on the neighboring template region and one of the guiding template regions. In some other implementations, the HoG may be generated only based on one of the guiding template regions. In other words, the encoder module 114 may generate multiple weighted prediction blocks based on the HoG, generated by filtering at least one of the neighboring template region and the guiding template regions.

In addition, the encoder module 114 may predict the block unit based on other prediction modes to generate multiple prediction blocks. The encoder module 114 may select one of the prediction blocks based on a mode selection method, such as a cost function. The mode selection method may be an RDO process, a Sum of Absolute Difference (SAD) process, a Sum of Absolute Transformed Difference (SATD) process, a Mean Absolute Difference (MAD) process, a Mean Squared Difference (MSD) process, and a Structural SIMilarity (SSIM) process. The encoder module 114 may provide the selected coding result to the first summer 7142 for generating a residual block and to the second summer 7145 for reconstructing the encoded block unit. The reconstruction of the block unit by the encoder module 114 may be identical to the reconstruction of the block unit by the decoder module 124.

The encoder module 114 may further encode the syntax elements into a bitstream, for transmitting to the decoder module 124. The syntax elements of the block unit may be used to determine a selected prediction candidate corresponding to the selected prediction block. In some implementations, the syntax elements, associated with the block unit, may further include multiple partition indications generated based on the partitioning of the block unit (e.g., based on any video coding standard).

In some implementations, when one of the weighted prediction blocks is selected to predict and/or reconstruct the block unit, the encoder module 114 may further provide syntax elements, such as a region index, included in the bitstream for transmitting to the decoder module 124. In some implementations, the region index of the block unit may be a block-level syntax element for selecting at least one of the neighboring template region and the guiding template regions.

Referring back to FIG. 6, after reconstructing the block unit (e.g., based on the HoG), the method/process 600 for the encoder module 114 may then end.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. A non-transitory machine-readable medium of an electronic device storing one or more computer-executable instructions for decoding video data, the one or more computer-executable instructions, when executed by at least one processor of the electronic device, causing the electronic device to:
receive the video data;
determine a block unit of an image frame included in the video data;
determine a plurality of template regions, including a plurality of template samples, from the image frame;
generate a first gradient amplitude by filtering a first set of template samples that is included in the plurality of template samples;
add the first gradient amplitude to a plurality of first histogram amplitudes in a first histogram of gradient (HoG);
calculate a cumulative sum of the plurality of first histogram amplitudes;
compare the cumulative sum of the plurality of first histogram amplitudes with an amplitude threshold, the amplitude threshold determined based on a size parameter of the block unit; and
reconstruct the block unit based on the first HoG when the cumulative sum of the plurality of first histogram amplitudes is greater than, or equal to, the amplitude threshold.

2. The non-transitory machine-readable medium of claim 1, wherein:
the plurality of template regions further includes at least one guiding region that is determined from a plurality of block-vector-guided regions, and
the plurality of block-vector-guided regions includes at least one block-vector-guided reference block and at least one block-vector-guided reference region, each of the at least one block-vector-guided reference region neighboring a corresponding one of the at least one block-vector-guided reference block.

3. The non-transitory machine-readable medium of claim 2, wherein the one or more computer-executable instructions, when executed by the at least one processor of the electronic device, further cause the electronic device to:
generate a second gradient amplitude by filtering a second set of template samples that is included in a specific one of the at least one guiding region, wherein:
the plurality of template regions further includes a neighboring region that neighbors the block unit and that is different from the plurality of block-vector-guided regions, and
the first set of template samples is included in the neighboring region and is different from the second set of template samples; and
add the second gradient amplitude to the plurality of first histogram amplitudes in the first HoG.

4. The non-transitory machine-readable medium of claim 3, wherein adding the second gradient amplitude to the plurality of first histogram amplitudes in the first HoG further comprises:
determining a magnitude of a block vector, wherein the specific one of the at least one guiding region is determined based on the block vector,
determining a weighted parameter of the second gradient amplitude based on the magnitude of the block vector,
multiplying the second gradient amplitude by the weighted parameter of the second gradient amplitude to generate a weighted amplitude, and
adding the weighted amplitude to the plurality of first histogram amplitudes in the first HoG.

5. The non-transitory machine-readable medium of claim 2, wherein reconstructing the block unit based on the first HoG comprises:
generating a second gradient amplitude by filtering a second set of template samples that is included in a specific one of the at least one guiding region, wherein:
the plurality of template regions further includes a neighboring region that neighbors the block unit and that is different from the plurality of block-vector-guided regions, and
the first set of template samples is included in the neighboring region and is different from the second set of template samples;
adding the second gradient amplitude to a plurality of second histogram amplitudes in a second HoG,
calculating a cumulative sum of the plurality of second histogram amplitudes;
comparing the cumulative sum of the plurality of second histogram amplitudes with the amplitude threshold; and
reconstructing the block unit further based on the second HoG when the cumulative sum of the plurality of second histogram amplitudes is greater than, or equal to, the amplitude threshold.

6. The non-transitory machine-readable medium of claim 1, wherein the one or more computer-executable instructions, when executed by the at least one processor of the electronic device, further cause the electronic device to:
when the cumulative sum of the plurality of first histogram amplitudes is greater than, or equal to, the amplitude threshold, terminate filtering the plurality of template samples; and
when the cumulative sum of the plurality of first histogram amplitudes is less than the amplitude threshold:
generate a second gradient amplitude by filtering a second set of template samples that is included in the plurality of template samples,
add the second gradient amplitude to the plurality of first histogram amplitudes in the first HoG,
update the cumulative sum of the plurality of first histogram amplitudes, and
compare the updated cumulative sum of the plurality of first histogram amplitudes with the amplitude threshold for determining whether to continue on filtering the plurality of template samples, wherein the second set of template samples is different from the first set of template samples.

7. The non-transitory machine-readable medium of claim 1, wherein:
determining the plurality of template regions from the image frame comprises determining the plurality of template regions based on a neighboring region that neighbors the block unit and that includes a plurality of neighboring lines, wherein a number of the plurality of neighboring lines is equal to a number N, wherein N is a positive integer, greater than one, and
the one or more computer-executable instructions, when executed by the at least one processor of the electronic device, further cause the electronic device to:
add one to the number N of the neighboring lines to update the plurality of template regions when all of the plurality of template samples has been filtered and the cumulative sum of the plurality of first histogram amplitudes is still less than the amplitude threshold; and
generate a second gradient amplitude by filtering a second set of template samples that is included in the plurality of updated template regions.

8. The non-transitory machine-readable medium of claim 1, wherein:
the amplitude threshold is equal to a first threshold candidate when the size parameter of the block unit is equal to, or less than, a size threshold,
the amplitude threshold is equal to, or greater than, a second threshold candidate when the size parameter of the block unit is greater than the size threshold,
the second threshold candidate is greater than the first threshold candidate, and
the first and second threshold candidates are positive integers.

9. The non-transitory machine-readable medium of claim 1, wherein the one or more computer-executable instructions, when executed by the at least one processor of the electronic device, further cause the electronic device to:
select a plurality of intra prediction modes from a plurality of intra angular modes based on the first HoG, wherein each of the plurality of first histogram amplitudes, that is included in the first HoG, corresponds to one of the plurality of intra angular modes;
predict the block unit based on the plurality of intra prediction modes to generate a plurality of intra-predicted blocks; and
reconstruct the block unit further by weightedly combining the plurality of intra-predicted blocks.

10. An electronic device for decoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit of an image frame included in the video data;
determine a plurality of template regions, including a plurality of template samples, from the image frame;
generate a first gradient amplitude by filtering a first set of template samples that is included in the plurality of template samples;
add the first gradient amplitude to a plurality of first histogram amplitudes in a first histogram of gradient (HoG);
calculate a cumulative sum of the plurality of first histogram amplitudes;
compare the cumulative sum of the plurality of first histogram amplitudes with an amplitude threshold, the amplitude threshold determined based on a size parameter of the block unit; and
reconstruct the block unit based on the first HoG when the cumulative sum of the plurality of first histogram amplitudes is greater than, or equal to, the amplitude threshold.

11. The electronic device of claim 10, wherein the one or more computer-executable instructions, when executed by the at least one processor of the electronic device, further cause the electronic device to:
generate a second gradient amplitude by filtering a second set of template samples that is included in a specific one of at least one guiding region, wherein:
the plurality of template regions includes a neighboring region, neighboring the block unit, and the at least one guiding region, determined from a plurality of block-vector-guided regions,
the plurality of block-vector-guided regions includes at least one block-vector-guided reference block and at least one block-vector-guided reference region, each of the at least one block-vector-guided reference region neighboring a corresponding one of the at least one block-vector-guided reference block,
the neighboring region is different from the plurality of block-vector-guided regions,
the first set of template samples is included in the neighboring region and is different from the second set of template samples,
the second gradient amplitude is added to the plurality of first histogram amplitudes in the first HoG or a plurality of second histogram amplitudes in a second HoG, and
reconstructing the block unit based on the first HoG is further based on the second HoG when the second gradient amplitude is added to the plurality of second histogram amplitudes in the second HoG.

12. The electronic device of claim 10, wherein:
determining the plurality of template regions from the image frame comprises determining the plurality of template regions based on a neighboring region that neighbors the block unit and that includes a plurality of neighboring lines, wherein a number of the plurality of neighboring lines is equal to a number N, wherein N is a positive integer, greater than one, and
the one or more computer-executable instructions, when executed by the at least one processor of the electronic device, further cause the electronic device to:
add one to the number N of the neighboring lines to update the plurality of template regions when all of the plurality of template samples has been filtered and the cumulative sum of the plurality of first histogram amplitudes is still less than the amplitude threshold; and
generate a second gradient amplitude by filtering a second set of template samples that is included in the plurality of updated template regions.

13. The electronic device of claim 10, wherein:
the amplitude threshold is equal to a first threshold candidate when the size parameter of the block unit is equal to, or less than, a size threshold,
the amplitude threshold is equal to, or greater than, a second threshold candidate when the size parameter of the block unit is greater than the size threshold,
the second threshold candidate is greater than the first threshold candidate, and
the first and second threshold candidates are positive integers.

14. An electronic device for encoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit of an image frame included in the video data;
determine a plurality of template regions, including a plurality of template samples, from the image frame;
generate a first gradient amplitude by filtering a first set of template samples that is included in the plurality of template samples;
add the first gradient amplitude to a plurality of first histogram amplitudes in a first histogram of gradient (HoG);
calculate a cumulative sum of the plurality of first histogram amplitudes;
compare the cumulative sum of the plurality of first histogram amplitudes with an amplitude threshold, the amplitude threshold determined based on a size parameter of the block unit; and
reconstruct the block unit based on the first HoG when the cumulative sum of the plurality of first histogram amplitudes is greater than, or equal to, the amplitude threshold.

15. The electronic device of claim 14, wherein the one or more computer-executable instructions, when executed by the at least one processor of the electronic device, further cause the electronic device to:
generate a second gradient amplitude by filtering a second set of template samples that is included in a specific one of at least one guiding region, wherein:
the plurality of template regions includes a neighboring region, neighboring the block unit, and the at least one guiding region, determined from a plurality of block-vector-guided regions,
the plurality of block-vector-guided regions includes at least one block-vector-guided reference block and at least one block-vector-guided reference region, each of the at least one block-vector-guided reference region neighboring a corresponding one of the at least one block-vector-guided reference block,
the neighboring region is different from the plurality of block-vector-guided regions, and
the first set of template samples is included in the neighboring region and is different from the second set of template samples; and
add the second gradient amplitude to the plurality of first histogram amplitudes in the first HoG.

16. The electronic device of claim 15, wherein adding the second gradient amplitude to the plurality of first histogram amplitudes in the first HoG further comprises:
determining a magnitude of a block vector, wherein the specific one of the at least one guiding region is determined based on the block vector,
determining a weighted parameter of the second gradient amplitude based on the magnitude of the block vector,
multiplying the second gradient amplitude by the weighted parameter of the second gradient amplitude to generate a weighted amplitude, and
adding the weighted amplitude to the plurality of first histogram amplitudes in the first HoG.

17. The electronic device of claim 14, wherein reconstructing the block unit based on the first HoG comprises:
generating a second gradient amplitude by filtering a second set of template samples that is included in a specific one of at least one guiding region, wherein:
the plurality of template regions includes a neighboring region, neighboring the block unit, and the at least one guiding region, determined from a plurality of block-vector-guided regions,
the plurality of block-vector-guided regions includes at least one block-vector-guided reference block and at least one block-vector-guided reference region, each of the at least one block-vector-guided reference region neighboring a corresponding one of the at least one block-vector-guided reference block,
the neighboring region is different from the plurality of block-vector-guided regions, and
the first set of template samples is included in the neighboring region and is different from the second set of template samples;
adding the second gradient amplitude to a plurality of second histogram amplitudes in a second HoG,
calculating a cumulative sum of the plurality of second histogram amplitudes;
comparing the cumulative sum of the plurality of second histogram amplitudes with the amplitude threshold; and
reconstructing the block unit further based on the second HoG when the cumulative sum of the plurality of second histogram amplitudes is greater than, or equal to, the amplitude threshold.

18. The electronic device of claim 14, wherein the one or more computer-executable instructions, when executed by the at least one processor of the electronic device, further cause the electronic device to:
when the cumulative sum of the plurality of first histogram amplitudes is greater than, or equal to, the amplitude threshold, terminate filtering the plurality of template samples; and
when the cumulative sum of the plurality of first histogram amplitudes is less than the amplitude threshold:
generate a second gradient amplitude by filtering a second set of template samples that is included in the plurality of template samples,
add the second gradient amplitude to the plurality of first histogram amplitudes in the first HoG,
update the cumulative sum of the plurality of first histogram amplitudes, and
compare the updated cumulative sum of the plurality of first histogram amplitudes with the amplitude threshold for determining whether to continue on filtering the plurality of template samples, wherein the second set of template samples is different from the first set of template samples.

19. The electronic device of claim 14, wherein:
determining the plurality of template regions from the image frame comprises determining the plurality of template regions based on a neighboring region that neighbors the block unit and that includes a plurality of neighboring lines, wherein a number of the plurality of neighboring lines is equal to a number N, wherein N is a positive integer, greater than one;
the one or more computer-executable instructions, when executed by the at least one processor of the electronic device, further cause the electronic device to:
add one to the number N of the neighboring lines to update the plurality of template regions when all of the plurality of template samples has been filtered and the cumulative sum of the plurality of first histogram amplitudes is still less than the amplitude threshold; and
generate a second gradient amplitude by filtering a second set of template samples that includes in the plurality of updated template regions.

20. The electronic device of claim 14, wherein:
the amplitude threshold is equal to a first threshold candidate when the size parameter of the block unit is equal to, or less than, a size threshold,
the amplitude threshold is equal to, or greater than, a second threshold candidate when the size parameter of the block unit is greater than the size threshold,
the second threshold candidate is greater than the first threshold candidate, and
the first and second threshold candidates are positive integers.
